(19) United States
(12) Patent Application Publication
(10) Pub. No.: US 2003/0180062 A1
(43) Pub. Date: Sep. 25, 2003

(54) Fixing device provided with calculation unit for calculating temperature of fixing member

(75) Inventor: Masashi Suzuki, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/390,707

(22) Filed: Mar. 19, 2003

(30) Foreign Application Priority Data
Mar. 25, 2002 (JP) 2002-083101
Aug. 29, 2002 (JP) 2002-251258

(51) Int. Cl. G03G 15/20

(52) U.S. Cl. 399/33; 399/67; 399/69; 399/336

(57) ABSTRACT

A fixing device is provided with a heat roller, which is brought into contact with a fixing medium to heat the same, and is further provided with a thermopile which is set in non-contact with the heat roller and detects a temperature of the heat roller based upon infrared rays irradiated from the heat roller. Moreover, the fixing device is provided with a direct measurement thermistor that is provided separately from the thermopile and set in direct contact with the heat roller. The temperature detected by the thermopile is corrected based upon a temperature detected by the direct measurement thermistor.

### BACKGROUND OF THE INVENTION

1. Field of the Invention

The present invention relates to a temperature calculation method for calculating a surface temperature of a fixing unit accurately based upon infrared rays irradiated from the fixing unit with an infrared ray sensor.

2. Description of the Related Art

A conventional laser printer is provided with a fixing device that fixes a toner image onto a recording sheet by thermal fusion. More specifically, the fixing device includes a heat roller having a heater for generating heat for fusing the toner and a temperature sensor for detecting a surface temperature of the heat roller. Based on the detected surface temperature, the heater is turned ON and OFF so as to maintain the surface of the heat roller at a temperature appropriate for fixing a toner image on a recording sheet.

There has been proposed a non-contact-type temperature sensor that detects the surface temperature of the heat roller without contacting the same. Because there is a danger that a contact-type temperature sensor scrapes off a fine toner clinging to the heat roller, and that the scraped toner overflows and clings to a recording sheet, the non-contact-type temperature sensor is preferable.

A thermopile is an example of such non-contact-type temperature sensors. A thermopile disclosed in Japanese Patent-Application Publication No. HEI-10-78728 is provided with a thermopile element. The thermopile element is a sensor that outputs voltage signals corresponding to an amount of received infrared rays. In general, an amount of infrared rays irradiated from a heating material, such as the heat roller, corresponds to a surface temperature thereof. Therefore, a surface temperature of the heat roller can be calculated by detecting the amount of the infrared rays from the heat roller using the thermopile.

The surface temperature is calculated based upon the Stefan-Boltzmann's Law, which is represented by the following equation

W=∫W_{λ}dλ=ηαT⁴

wherein:

λ is a wavelength (zero to infinite),

W is radiation energy of a blackbody,

W_{λ} is radiation energy of the blackbody for each wavelength,

α is the Stefan-Boltzmann constant,

η is an emissivity of the blackbody, and

T is a temperature of the blackbody.

That is, a radiation energy W of a blackbody is found by integrating a radiation energy of each wavelength W_{λ} of light irradiated from the blackbody in a whole wavelength (zero to infinite). Then, a temperature T of the blackbody is derived from the radiation energy W. In the similar manner, the output voltage of the thermopile is proportional to a radiation energy of the heat roller. Accordingly, the surface temperature of the heat roller can be calculated based on the received amount of the infrared rays irradiated from the heat roller.

However, output signal of the infrared ray sensor, such as the thermopile, varies when humidity in a fixing device changes even if an actual surface temperature of the heat roller is the same. This is because water vapor absorbs infrared rays of specific wavelengths. The humidity in the fixing device changes largely during operations of the laser printer because moisture contained in a recording sheet evaporates when the fixing device warms the recording sheet for fixing toner images. The humidity in the fixing device also changes according to a humidity of the outside air. In this manner, humidity in the fixing device prevents accurate detection of the surface temperature of the heat roller.

In order to overcome such a problem, the conventional thermopile is provided with a filter for cutting infrared rays in a predetermined wavelength region that water vapor absorbs. In this way, the thermopile receives only infrared rays in a wavelength region that water vapor does not absorb, so that the surface temperature of the heat roller is calculated without being affected by the humidity in the fixing device.

However, as shown in FIG. 7, the radiation energy of each wavelength W_{λ} has a different distribution according to a temperature, and peaks of the distributions exhibit a variation called the Wien's Displacement Law. Therefore, if infrared rays of the predetermined wavelengths areas are cut using the filter in a manner described above, a total radiation energy of the heat roller, which is in proportion to the temperature of the heat roller, and the output voltage of the thermopile are not proportional to each other. Accordingly, the temperature of the heat roller could be calculated erroneously.

In addition, characteristics of thermopile elements greatly vary among products, causing variation in an output voltage on the order of ±20% among the thermopile elements. Such a variation causes an error in the temperature measurement, preventing an accurate temperature control of the heat roller.

Moreover, since the output voltage of the thermopile is as faint as several tens mV, the voltage is amplified with an amplifier circuit. This causes temperature drift or the like, preventing improvement of measurement accuracy.

### SUMMARY OF THE INVENTION

In the view of foregoing, it is an object of the present invention to overcome the above problems, and also to provide a fixing device that calculates a surface temperature of a heat roller accurately.

In order to attain the above and other objects, the present invention provides a temperature calculating method for calculating a surface temperature of a fixing unit that thermally fixes a fixed medium onto a fixing medium. The method includes the steps of detecting a level of an electric signal from an infrared ray sensor that is provided in a non-contact manner with the surface of the fixing unit, and receives infrared rays emitted from the surface of the fixing unit, the level corresponding to an amount of the received infrared rays, detecting a temperature of the infrared ray sensor by using a temperature sensor provided to the infrared ray sensor, and calculating the surface temperature of the fixing unit based on the level of the electric signal outputted from the infrared ray sensor and the temperature of the infrared ray sensor detected by the temperature sensor using an equation:

T={(k₁·P+k₂+T₀⁴)/ε}^{1/4}

wherein

T is the surface temperature of the fixing unit;

P is the level of the electric signal outputted from the infrared ray sensor;

k₁ is a constant specific to the infrared ray sensor;

k₂ is a constant specific to the infrared ray sensor;

T₀ is the temperature of the infrared ray sensor detected by the temperature sensor; and

ε is an emissivity of infrared rays of the fixing unit.

The present invention also provides a program for calculating a surface temperature of a fixing unit that thermally fixes a fixed medium onto a fixing medium. The program includes the programs of detecting a level of an electric signal from an infrared ray sensor that is provided in a non-contact manner with the surface of the fixing unit, and receives infrared rays emitted from the surface of the fixing unit, the level corresponding to an amount of the received infrared rays, detecting a temperature of the infrared ray sensor by using a temperature sensor provided to the infrared ray sensor, and calculating the surface temperature of the fixing unit based on the level of the electric signal outputted from the infrared ray sensor and the temperature of the infrared ray sensor detected by the temperature sensor using an equation:

T={(k₁·P+k₂+T₀⁴)/ε}^{1/4}

wherein

T is the surface temperature of the fixing unit;

P is the level of the electric signal outputted from the infrared ray sensor;

k₁ is a constant specific to the infrared ray sensor;

k₂ is a constant specific to the infrared ray sensor;

T₀ is the temperature of the infrared ray sensor detected by the temperature sensor; and

ε is an emissivity of infrared rays of the fixing unit.

The present invention also provides a fixing device and an image forming device including the fixing device. The fixing device includes a fixing unit that thermally fixes a fixed medium onto a fixing medium, an infrared ray sensor provided in a non-contact manner with a surface of the fixing unit, the infrared ray sensor receiving infrared rays emitted from the surface of the fixing unit and outputting an electric signal of a level corresponding to an amount of the received infrared rays, a temperature sensor that detects a temperature of the infrared ray sensor, and a temperature detection unit that detects a surface temperature of the fixing unit based both on the level of the electric signal outputted from the infrared ray sensor and on the temperature of the infrared ray sensor detected by the temperature sensor using an equation:

T={(k₁·P+k₂+T₀⁴)/ε}^{1/4}

wherein

T is the surface temperature of the fixing unit;

P is the level of the electric signal outputted from the infrared ray sensor;

k₁ is a constant specific to the infrared ray sensor;

k₂ is a constant specific to the infrared ray sensor;

T₀ is the temperature of the infrared ray sensor detected by the temperature sensor; and

ε is an emissivity of infrared rays of the fixing unit.

The present invention also provides a fixing device and an image forming device including the fixing device. The fixing device includes a fixing unit that contacts a fixing medium and heats the fixing medium, an infrared ray detection unit provided in a non-contact manner with a surface of the fixing unit, the infrared ray detection unit receiving infrared rays emitted from the surface of the fixing unit and outputting an electric signal of an output value corresponding to an amount of the received infrared rays, a first temperature detection unit that detects an actual temperature of the fixing unit, a correction unit that corrects the output value into an ideal output value based on the temperature detected by the first temperature detection unit, and a second temperature detection unit that detects a temperature of the fixing unit based on the ideal output value.

The present invention also provides a fixing device and an image forming device including the fixing device. The fixing device includes a fixing unit that contacts a fixing medium and heats the fixing medium, a temperature detection unit provided in a non-contact manner with a surface of the fixing unit, the temperature detection unit detecting a temperature of the fixing unit based on an amount of infrared rays emitted from the surface of the fixing unit, and a temperature control unit that controls the temperature of the fixing unit based on the temperature detected by the temperature detection unit, wherein the temperature control unit further includes an amplifier circuit that amplifies an electric power outputted from the temperature detection unit, and a temperature compensating circuit that cancels a temperature drift of the amplifier circuit.

### BRIEF DESCRIPTION OF THE DRAWINGS

In the drawings:

FIG. 1 is a cross-sectional side view showing an overall structure of a laser printer of embodiments of the present invention;

FIG. 2 is a sectional view for explaining a positional relationship among a heat roller, a thermopile, and a peeling pawl of a first embodiment;

FIG. 3 is an exploded perspective view of the thermopile;

FIG. 4 is a graph illustrating an absorptance of infrared rays which has traveled several kilometers through the atmosphere, in which a wavelength of the infrared ray is shown on the horizontal axis and the absorptance of the infrared ray is shown on the vertical axis;

FIG. 5 is a block diagram of a control apparatus of the first embodiment;

FIG. 6 is a graph showing a voltage level of a thermopile element on the horizontal axis and εT⁴−T₀⁴ on the vertical axis;

FIG. 7 is a graph illustrating a relationship between a blackbody radiation energy and a wavelength;

FIG. 8 is a sectional view for explaining a positional relationship among a heat roller, a thermopile, a direct measurement thermistor, and a peeling pawl of a second embodiment;

FIG. 9 is a block diagram of a control apparatus of the second embodiment;

FIG. 10 is a flowchart representing a main control process of the second embodiment;

FIG. 11 shows an example of a correspondence table;

FIG. 12 is explanatory diagram showing how to derive an ideal output voltage of a thermopile element using the correspondence table of FIG. 11;

FIG. 13 shows a group of correction tables;

FIG. 14 is explanatory diagram showing how to select a correction table based upon an ideal output voltage and an actual output voltage of the thermopile element;

FIG. 15 is explanatory diagram showing how to correct an actual output value of the thermopile element into an ideal output value using the selected correction table;

FIG. 16 is explanatory diagram showing how to calculate a temperature of the heat roller from the ideal output value of the thermopile element and an output value of an internal thermistor;

FIG. 17 is a block diagram of a control apparatus of a third embodiment;

FIG. 18 is a flowchart representing a main control process of the third embodiment;

FIG. 19 is a block diagram of a control apparatus according to modification of the third embodiment;

FIG. 20 is a graph illustrating a correspondence relation in a fourth embodiment;

FIG. 21 is a graph illustrating a correction equation in the fourth embodiment;

FIG. 22 is a flowchart of the fourth embodiment;

FIG. 23 is a block diagram of a control apparatus of a fifth embodiment;

FIG. 24 is a flowchart representing a control process of the fifth embodiment; and

FIG. 25 is a circuit diagram for amplifying an output voltage of a thermopile.

### DETAILED DESCRIPTION OF THE PREFERRED EMBODIMENTS

Next, embodiments of the present invention will be described.

First, a first embodiment will be described.

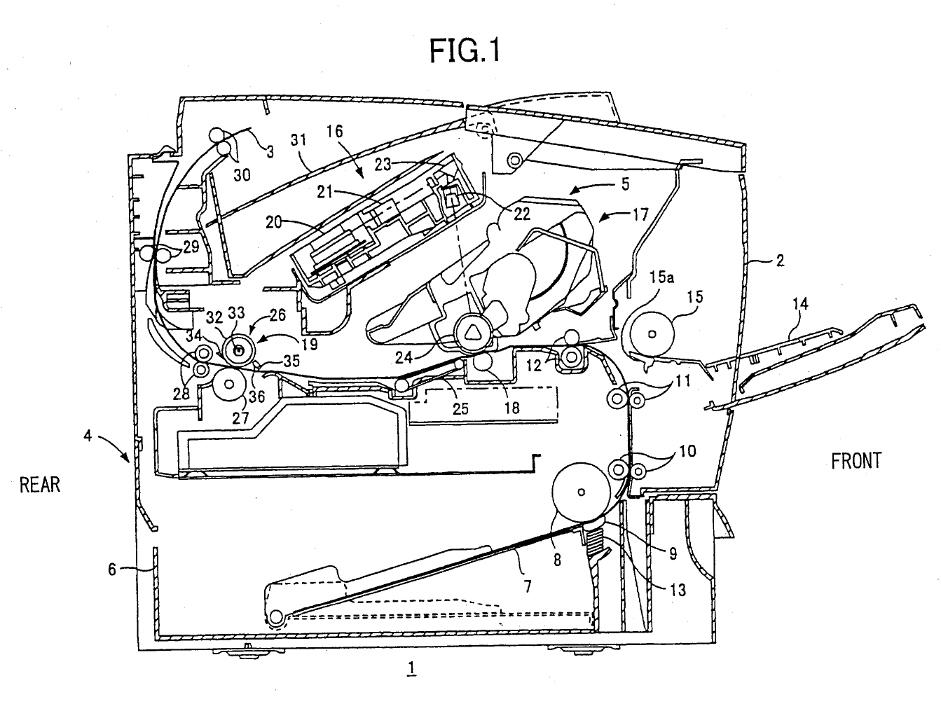

As shown in FIG. 1, a laser printer 1 includes a main body casing 2 accompanying a feeder unit 4 for feeding a recording sheet 3 and an image forming unit 5 for forming images on the recording sheet 3.

The feeder unit 4 includes a sheet feeding tray 6, a sheet pressing plate 7, a sheet feeding roller 8, a sheet feeding pad 9, conveying rollers 10 and 11, and a registration roller 12. The sheet feeding tray 6 is detachably mounted to the bottom of the main body casing 2. The sheet pressing plate 7 is provided in the sheet feeding tray 6. The sheet feeding roller 8 and the sheet feeding pad 9 are provided above a front end of the sheet feeding tray 6. The conveying rollers 10 and 11 are disposed on a downstream side of the sheet feeding roller 8 with respect to a sheet conveying direction of the recording sheet 3. The registration roller 12 is provided on a downstream side of the conveying rollers 10 and 11 with respect to the sheet conveying direction (An upstream side or a downstream side in the sheet conveying direction will be simply referred to as “upstream side” or “downstream side” hereinafter).

A stack of recording sheets 3 is mounted on the sheet pressing plate 7. The sheet pressing plate 7 is swingably supported at a rear end, such that a front end moves in a vertical direction. Although not shown in the drawings, a spring is provided below the sheet pressing plate 7 to urge the sheet pressing plate 7 upward. Therefore, as a stacked amount of the recording sheets 3 increases, the sheet pressing plate 7 is swung downward against the urging force of the spring with the rear end as a fulcrum. The sheet feeding pad 9 is pressed toward the sheet feeding roller 8 by a spring 13 disposed below the sheet feeding pad 9. An uppermost sheet of the recording sheets 3 stacked on the sheet pressing plate 7 is pressed against the sheet feeding roller 8 by the urging force of the spring, nipped by the sheet feeding roller 8 and the sheet feeding pad 9, and fed to the conveying roller 10 in accordance with a rotation of the sheet feeding roller 8 one at a time. The recording sheet 3 is further fed to the registration roller 12 by the conveying rollers 10 and 11. The registration roller 12 includes a pair of rollers and sends the recording sheet 3 to the image forming unit 5 after applying predetermined registration to the recording sheet 3.

The feeder unit 4 further includes a multi-purpose tray 14, a multi-purpose sheet feeding roller 15, and a multipurpose sheet feeding pad 15a. The multi-purpose sheet feeding pad 15a is pressed against the multi-purpose sheet feeding roller 15 by a spring (not shown) disposed beneath the multipurpose sheet feeding pad 15a. Uppermost one of the recording sheets 3 stacked on the multi-purpose tray 14 is nipped between the multi-purpose sheet feeding roller 15 and the multi-purpose sheet feeding pad 15a and supplied to the registration roller 12 one by one as the multi-purpose sheet feeding roller 15 rotates.

The image forming unit 5 includes a scanner unit 16, a process cartridge 17, a transfer roller 18, a fixing device 19, and the like. The scanner unit 16 is provided in an upper part in the main body casing 2 and includes a laser beam emission unit (not shown), a polygon mirror 20 to be driven to rotate, lenses 21 and 22, a reflecting mirror 23, and the like. The laser beam emission unit emits a laser beam based on image data. The laser beam passes through or reflects on the polygon mirror 20, the lens 21, the reflecting mirror 23, and the lens 22 in this order as indicated by a dotted chain line, and irradiates on a surface of a photosensitive drum 24 of the process cartridge 17 through high speed scanning.

The process cartridge 17 is detachably mounted on the main body casing 2 below the scanner unit 16. The process cartridge 17 includes the photosensitive drum 24, a scorotron charger, a developing roller, a toner containing unit, and the like (not shown).

The toner containing unit contains a nonmagnetic single-component polymeric toner having a positive charging property. The toner is carried on the developing roller as a thin toner layer of a certain thickness. The photosensitive drum 24 is rotatably disposed in confrontation with the developing roller. A main body of the photosensitive drum 24 is grounded, and a surface of the photosensitive drum 24 is formed of a photosensitive layer with a positive charging property formed of polycarbonate or the like.

After being uniformly charged positively by the scorotron charger, the surface of the photosensitive drum 24 is exposed through high speed scanning of a laser beam from the scanner unit 16, so that an electrostatic latent image corresponding to image data is formed thereon. Positively charged toner on the developing roller is selectively supplied to the electrostatic latent image on the surface of the photosensitive drum 24, that is, to a part which is exposed by the laser beam and has a decreased electric potential. In this manner, a visible reversal toner image is developed.

The transfer roller 18 is rotatably disposed below the photosensitive drum 24. The transfer roller 18 has a metal roller shaft coated with a roller made of a conductive rubber material, and a predetermined transfer bias is applied to the photosensitive drum 24, so that the toner image formed on the photosensitive drum 24 is transferred onto the recording sheet 3 passing between the photosensitive drum 24 and the transfer roller 18. The recording sheet 3 with the toner image formed thereon is conveyed to the fixing device 19 by a conveyor belt 25.

The fixing device 19 is disposed on the downstream side of the process cartridge 17, and includes a heat roller 26, a pressure roller 27, and a conveying roller 28. The heat roller 26 has a cylindrical main body 32 made of a metal, such as aluminum, and a halogen lamp 33. The halogen lamp 33 is provided along an axial direction inside the roller main body 32. The halogen lamp 33 generates heat when supplied electric power from a power source (not shown), so as to heat the main body 32. The pressure roller 27 is opposed to the heat roller 26 across a conveying path of the recording sheet 3. The pressure roller 27 includes a metal roller shaft coated with an elastic roller. The pressure roller 27 presses against the heat roller 26 with a predetermined pressure to form a nip portion therebetween, so that the toner image transferred onto the recording sheet 3 is heated and fixed on the recording sheet 3 while the recording sheet 3 passes through the nip portion. The conveying roller 28 is provided on the downstream side of the heat roller 26 and the pressure roller 27.

A conveying roller 29 provided on the downstream side of the fixing device 19 conveys the recording sheet 3 discharged from the fixing device 19 to a sheet discharge roller 30. The sheet discharge roller 30 discharges the recording sheet 3 onto a sheet discharge tray 31.

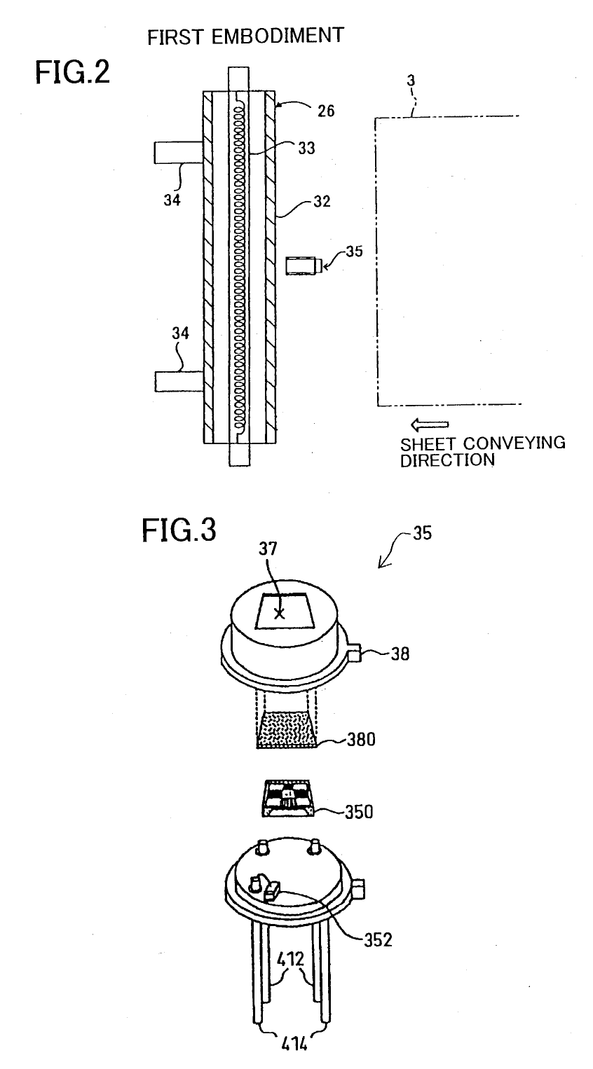

The fixing device 19 further includes a pair of peeling pawls 34 and the thermopile 35. The peeling pawls 34 are for peeling off the recording sheet 3 adhered to the surface of the heat roller 26. As shown in FIG. 2, two peeling pawls 34 are spaced a predetermined distance apart from each other and disposed at both lengthwise ends of the heat roller 26 on a downstream side of the nip portion between the heat roller 26 and the pressure roller 27. Rear ends of the peeling pawls 34 are supported by a casing (not shown) of the fixing device 19, and front ends are opposed to the heat roller 26.

The peeling pawl 34 is made of a metal. As shown in FIGS. 1 and 2, the peeling pawl 34 has a substantially rectangular thin plate in a plan view and a substantially wedge shape in a sectional view, having a smaller thickness toward the front end. The peeling pawls 34 are spaced apart from the heat roller 26 usually. However, the peeling pawls 34 are brought into contact with the surface of the heat roller 26 by a solenoid (not shown) only when the recording sheet 3 is supplied to the fixing device 19 so as to scrape off the recording sheet 3 from the surface of the heat roller 26.

The thermopile 35 is for detecting infrared rays emitted from the surface of the heat roller 26. The thermopile 35 is disposed on the upstream side of the nip portion between the heat roller 26 and the pressure roller 27 at a position apart from the heat roller 26 by a predetermined distance. The thermopile 35 is disposed in substantially the longitudinal center of the heat roller 26 and does not overlap the peeling pawls 34 in the axial direction of the heat roller 26. The thermopile 35 has an infrared ray incident port 37 opposed to the surface of the heat roller 26.

As shown in FIG. 3, the thermopile 35 has a thermopile element 350, an internal thermistor 352, and a tubular can case 38 accommodating the thermopile element 350 and the internal thermistor 352. The infrared ray incident port 37 having a substantially rectangular shape is opened in the can case 38. The thermopile element 350 is formed in a substantially rectangular plate shape and opposed to the infrared ray incident port 37. When the thermopile element 350 receives infrared rays irradiated from the surface of the heat roller 26, the thermopile 35 outputs a voltage signal corresponding to a received amount of the infrared rays from a pair of output pins 412. The internal thermistor 352 detects a temperature of the thermopile element 350 and outputs a voltage signal corresponding to the temperature via a pair of output pins 414.

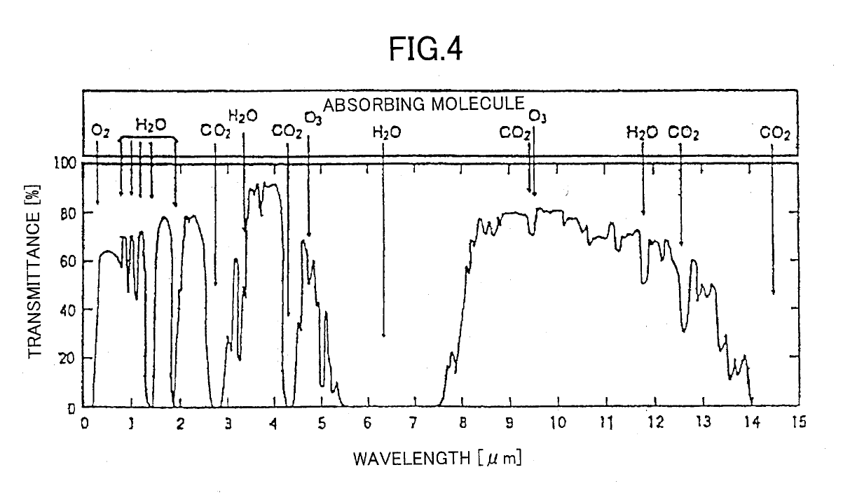

An optical filter 380 for cutting infrared rays with a wavelength equal to or shorter than 2 μm is provided in the infrared ray incident port 37. The optical filter 380 is provided because infrared rays around a wavelength 1.45 μm and around 1.94 μm tend to be absorbed by water vapor as Mr. Toshiaki Kawai of Hamamatsu Photonics K. K. has released at the 92nd regular meeting of the Society of Sensing Technology of Japan (Friday, Aug. 19, 1994, at the conference room of Mita Shuppan Kai). FIG. 4 shows a relationship between a transmittance and a wavelength of infrared rays that have transmitted several kilometers in the atmosphere. As shown in FIG. 4, infrared rays with wavelengths of 5 to 8 μm are absorbed in water vapor while transmitting several kilometers through the atmosphere. However, because a distance from the surface of the heat roller 26 to the thermopile element 350 is approximately 20 mm to 30 mm in the fixing device 19, infrared rays with wavelengths of 5 to 8 μm reach the thermopile element 350 without being absorbed so much as infrared rays with a wavelength of 1.45 μm or 1.94 μm. Therefore, it is sufficient to cut only infrared rays with wavelengths of 2 μm or less. However, in order to detect a temperature more accurately, it is desirable to use an optical filter that cuts infrared rays with wavelengths of 8 μm or less as the optical filter 380.

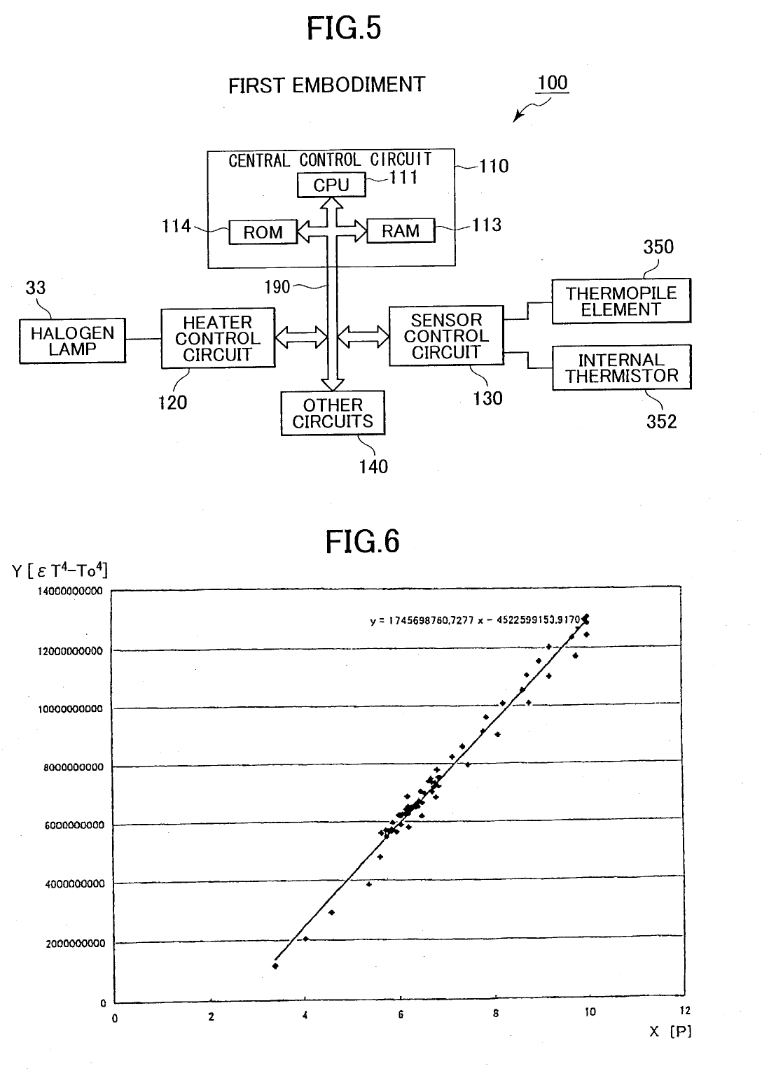

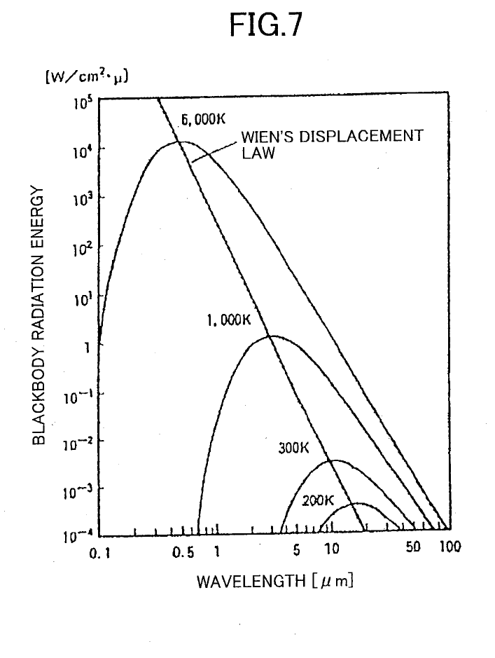

Next, a control apparatus 100 of the laser printer 1 will be described with reference to FIG. 5. As shown in FIG. 5, the control apparatus 100 includes a central control circuit 110, a heater control circuit 120, a sensor control circuit 130, and other circuits 140, all connected one another by a bus 190.

The central control circuit 110 includes a central processing unit (CPU) 117, a random access memory (RAM) 113, and a read only memory (ROM) 114, and executes various controls. The RAM 113 is for temporarily storing data on the output voltage of the thermopile element 350 and the internal thermistor 352. The ROM 114 is for storing various programs, such as a calculation program for calculating a surface temperature of the heat roller 26 and a main control program.

A halogen lamp 33 is connected to the heater control circuit 120, and the heater control circuit 120 controls ON and OFF of the halogen lamp 33 in accordance with the main control program stored in the ROM 114.

The thermopile element 350 and the internal thermistor 352 are connected to the sensor control circuit 130. The sensor control circuit 130 receives the voltage signal of the thermopile element 350 corresponding to an amount of received infrared rays, A/D converts the received output signal into digital data, and outputs the digital data to the RAM 113 via the bus 190. In the similar manner, the sensor control circuit 130 receives the output signal of the internal thermistor 352 corresponding to the temperature of the thermopile element 350, A/D converts the received output signal into digital data, and outputs the digital data to the RAM 113 via the bus 190. In this manner, data on output voltage of the thermopile element 350 and data on the output voltage of the internal thermistor 352 are stored in the RAM 113.

Here, it is known that a relationship between a voltage level P of the output signal of the thermopile element 350 and the actual surface temperature T of the heat roller 26 is represented by equation (1) according to the Stefan-Boltzmann's Law.

P=k{εT⁴−T₀⁴} (1)

wherein,

k is a constant specific to the thermopile element 350,

T₀ is a temperature of the thermopile element 350 itself, and

ε is an emissivity of infrared rays of the heat roller 26.

In addition, it was found from an experiment that when the voltage level P was actually measured, εT⁴−T₀⁴ is plotted along a straight line represented by k₁·P+k₂ using the output level P of the thermopile element 350 and constants k₁ and k₂ specific to the thermopile element 350.

Accordingly, the surface temperature T of the heat roller 26 is represented by equation (2) shown below.

T={(k₁·P+k₂+T₀⁴)/ε}^{1/4} (2)

whrein,

k₁ and k₂ are constants specific to the thermopile element 350, and

ε is a specific constant representing an emissivity of infrared rays of the heat roller 26.

Values of these constants k₁, k₂ and E can be obtained from an experiment or the like and substituted in the equation (2). Thus prepared equation (2) is stored in the ROM 114.

Here, examples of the constants k₁ and k₂ used in the equation (2) will be described. A heat roller used in this example as the heat roller 26 is manufactured by stacking and baking a primer and a PFA on a surface of an aluminum element pipe and has an emissivity of infrared rays of ε=0.5. A thermopile IRTE5021TC01 manufactured by Murata Manufacturing Co., Ltd. is used as the thermopile 35.

FIG. 6 is a graph showing P on the horizontal axis and εT⁴−T₀⁴ on the vertical axis. P is a voltage level of the thermopile element 350 amplified by 100 times by an operational amplifier.

In order to find k₁ and k₂, first a thermistor is placed on the surface of the heat roller 26. Then, the temperature of the heat roller 26 is gradually raised by turning ON the halogen lamp 33, while measuring the actual surface temperature T of the heat roller 26 using the thermistor, the voltage level P of the thermopile element 350, and the temperature T₀ of the thermopile element 350 using the internal thermistor 352 of the thermopile 35. εT⁴−T₀⁴ corresponding to the output level P of the thermopile element 350 is plotted as in the graph shown in FIG. 6. As a result, εT⁴−T₀⁴ is plotted along a straight line k₁·P+k₂ as shown in FIG. 6. Therefore, the following equation (3) is obtained:

k₁·P+k₂=εT⁴−T₀⁴ (3)

Thus, the above equation (2) is derived from this equation (3)

Note that k₁ and k₂ in the example of FIG. 6 are 1745698760.7277 and −4522599153.9170, respectively.

Next, main control process executed by the central control circuit 110 for controlling the temperature of the heat roller 26 will be described. This process is executed each time when the data relating to the output voltage of the thermopile element 350 and the internal thermistor 352 are stored in the RAM 113. First, the central control circuit 110 calculates the temperature of the thermopile element 350 based upon the output voltage of the internal thermistor 352. Since this process is well known, a description of details thereof will be omitted.

Next, the central control circuit 110 calculates the surface temperature T of the heat roller 26 using the equation (2). That is, the central control circuit 110 substitutes the output voltage of the thermopile element 350 for P and the calculated temperature of the thermopile element 350 for T₀ in the equation (2), and calculates the surface temperature T of the heat roller 26. The calculated surface temperature T is stored in the RAM 113. Then, the central control circuit 110 controls ON and OFF of the halogen lamp 33 via the heater control circuit 120 so as to maintain the surface temperature of the heat roller 26 to a temperature most suitable for fixing a toner image on the recording sheet 3.

As described above, according to the present embodiment, since the optical filter 380 cuts infrared rays in wavelength area that are absorbed into water vapor, output voltage of the thermopile element 350 is not affected by the change in humidity. Also, because the surface temperature of the heat roller 26 is calculated based on the output voltage of the thermopile element 350 using the equation (2), the surface temperature of the heat roller 26 can be accurately calculated.

An infrared ray sensor of a type that detects temperature change of an object does not output a detection signal unless temperature of the object changes. Thus, in order to detect the temperature of the object continuously using this type of sensor, it is necessary, for example, to provide a shutter between the object and the sensor for intermittently passing infrared rays. This makes an apparatus structure complicated.

However, since the thermopile element 350 used in the present embodiment can continuously detect a received amount of infrared rays even if there is no change in temperature, it is possible to detect the temperature continuously using a simpler structure without the shutter or the like.

Further, because the fixing device 19 can control the temperature of the heat roller 26 in the above-described precise manner, the fixing device 19 can reliably fix the toner images onto the recording sheet 3.

In this embodiment, the temperature T is calculated using the equation (2). However, it is also possible to use a table showing a relationship among the voltage level P of the thermopile element 350, the temperature T₀ of the internal thermistor 352, and the surface temperature T of the heat roller 26, and read out the surface temperature T from the table based upon the voltage level P and the detected temperature T₀. In this way, the surface temperature T can be obtained merely by reading the surface temperature T from the table based upon the voltage level P and the detected temperature T₀, reducing a load exerted on the central control circuit 110 for calculating the surface temperature T of the heat roller 26. The table may be stored in the ROM 114, but a place of the storage is not specifically limited.

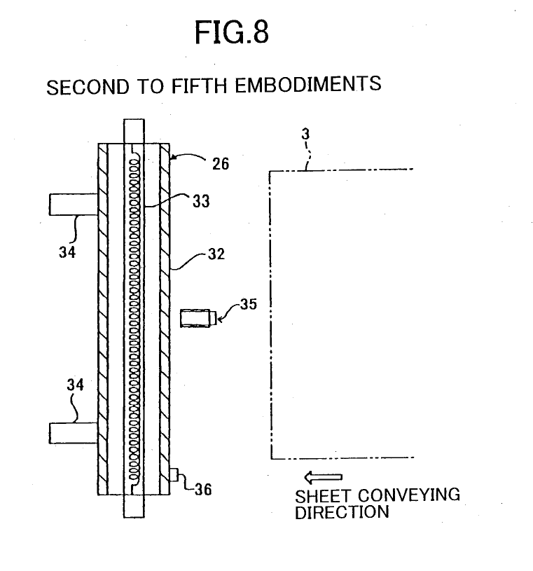

Next, a second embodiment of the present invention will be described with reference to FIGS. 8 to 16.

Since an overall structure of the laser printer 1 and a structure of the thermopile 35 in the second embodiment are the same as those in the first embodiment, descriptions thereof will be omitted.

As shown in FIG. 8, the fixing device 19 in the second embodiment is provided with a thermistor (this thermistor will be hereinafter referred to as “direct measurement thermistor”) 36 in addition to the internal thermistor 352 of the thermopile 35. The direct measurement thermistor 36 is for detecting a temperature of the heat roller 26, and attached directly to the surface of the heat roller 26 at a lengthwise end thereof. The direct measurement thermistor 36 is disposed outside an area where the recording sheet 3 comes in contact. A resistance of the direct measurement thermistor 36 changes according to the temperature of the heat roller 26, so that the direct measurement thermistor 36 outputs a voltage signal corresponding to the temperature of the heat roller 26.

Note that the laser printer 1 is capable of printing on the recording sheet 3 of various sizes such as B5 and A4. The direct measurement thermistor 36 is attached to a part outside an area where a sheet of a maximum printable size comes into contact with.

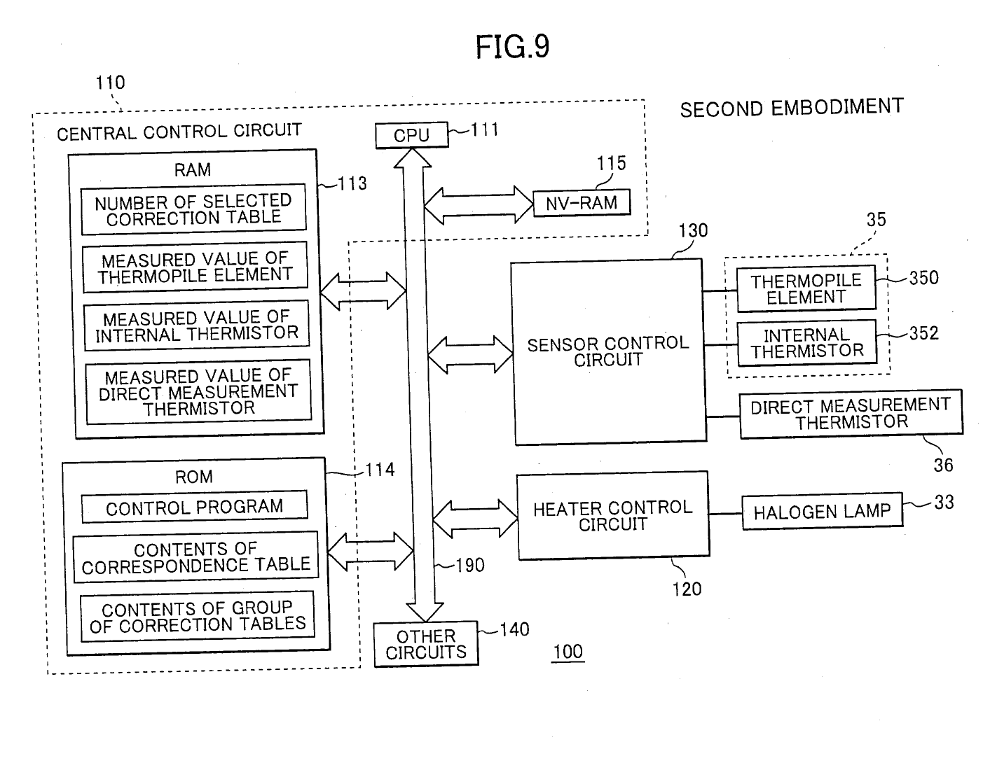

As shown in FIG. 9, the control apparatus 100 of the second embodiment is provided with the central control circuit 100, the heater control circuit 120, the sensor control circuit 130, and other circuits 140, all are connected one another by the bus 190. The central control circuit 110 includes the CPU 111, the RAM 113, the ROM 114, and an NV-RAM 115, and executes various controls.

The RAM 113 stores data on the output voltage of the thermopile element 350, data on the output voltage of the internal thermistor 352, data on the output voltage of the direct measurement thermistor 36, and the like. The ROM 114 stores, in addition to various programs, a correspondence table and correction tables to be discussed later. The NV-RAM 115 is a non-volatile memory which keeps stored contents even if a power supply is turned OFF. The NV-RAM 115 stores various parameters.

The halogen lamp 33 is connected to the heater control circuit 120. ON/OFF of the halogen lamp 33 is controlled by the central control circuit 110. The thermopile element 350 and the internal thermistor 352 of the thermopile 35 and the direct measurement thermistor 36 are connected to the sensor control circuit 130 individually. The CPU 111 controls the sensor control circuit 130 to A/D convert the voltage signals from the thermopile element 350 and the internal thermistor 352 and to transmit resultant data to the CPU 111. The CPU 111 also controls the sensor control circuit 130 to A/D convert the voltage signal from the direct measurement thermistor 36 and to transmit the resultant data to the CPU 111. In this manner, the CPU 111 can obtain the voltage level of the signals from the thermopile element 350, the internal thermistor 352, and the direct measurement thermistor 36.

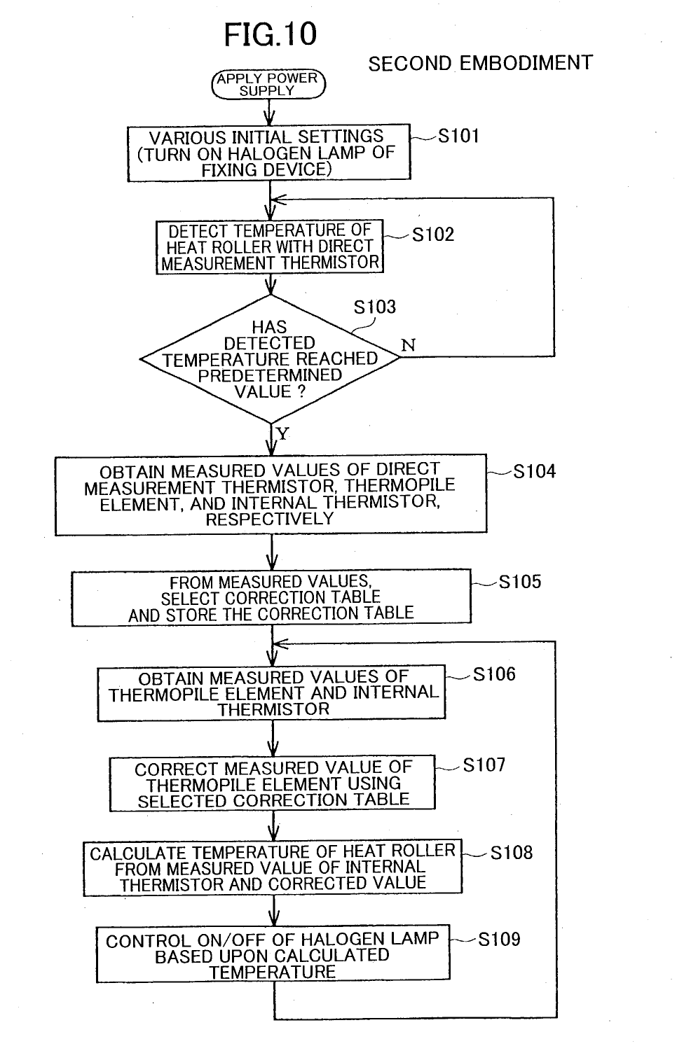

Next, control process according to the present embodiment will be described with reference to a flowchart of FIG. 10.

The control process is started when the laser printer 1 is turned ON. Once the control process starts, first, the CPU 111 performs initialization process to read the main control program from the ROM 114, for example, and then, immediately controls the heater control circuit 120 to turn ON the halogen lamp 33 so as to heat up the heat roller 26 (step 101). Step will be hereinafter abbreviated as “S”. In this manner, warm-up of the fixing device 19 is started.

Then, the process enters a loop of S102 to S103. In this loop, the CPU 111 measures a temperature of the heat roller 26 with the direct measurement thermistor 36 (S102) and compares the measured temperature with a predetermined temperature (e.g., 150° C.) that is suitable for fixing a toner. The CPU 111 then determines whether or not the measured temperature has reached the predetermined temperature (S103). If not (S103: No), then the process returns to S102 while keeping the halogen lamp 33 ON. On the other hand, if so (S103: Yes), then the CPU 111 leaves this loop. In this way, the temperature of the heat roller 26 is raised to the temperature suitable for fixing a toner, and the warm-up of the fixing device 19 is completed.

Next, the CPU 111 obtains voltage levels of the direct measurement thermistor 36, the thermopile element 350, and the internal thermistor 325 from the sensor control circuit 130, and stores the obtained values into the RAM 113 (S104). Then, the CPU 111 selects one of correction tables based on these values, and stores the selected correction table in the RAM 113 (S105).

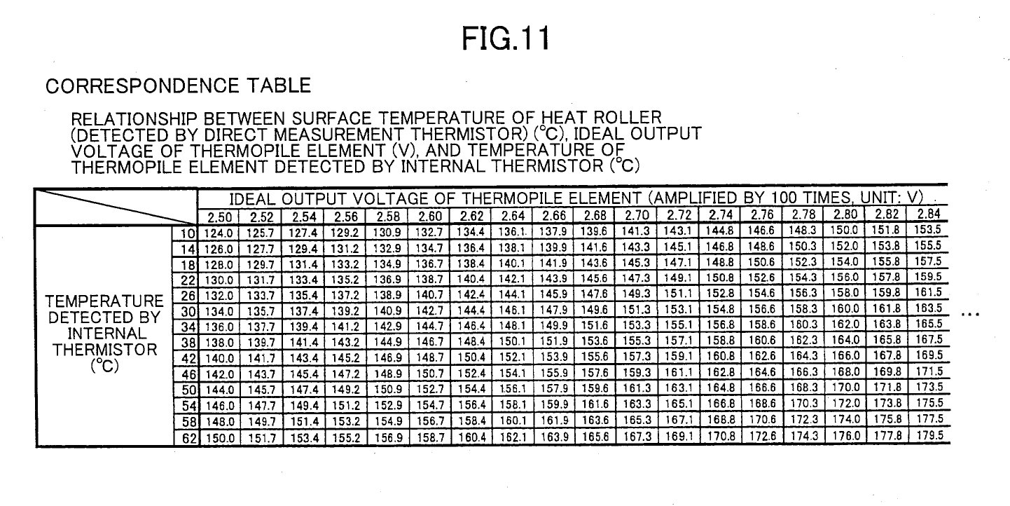

The correction table is selected by a method described next. The correspondence table shown in FIG. 11 is stored in the ROM 114. The correspondence table shows a relationship among the surface temperature of the heat roller 26 detected by the direct measurement thermistor 36, an ideal output voltage of the thermopile element 350, and a temperature of the thermopile element 350 detected by the internal thermistor 352 (hereinafter referred to as “measurement temperature of the internal thermistor 352”). The correspondence table represents the fact that an output voltage of the thermopile element 350 is a function of a temperature of the heat roller 26, and a temperature of the thermopile element 350 (the Stefan-Bolzmann's Law) as a one-to-one relationship of respective specific values. That is, the values in the correspondence table can be obtained using the equation (2) shown in the first embodiment, for example.

First, the CPU 111 obtains an ideal output voltage of the thermopile element 350 using the correspondence table based on the measurement temperature of the internal thermistor 352 and output value of the direct measurement thermistor 36.

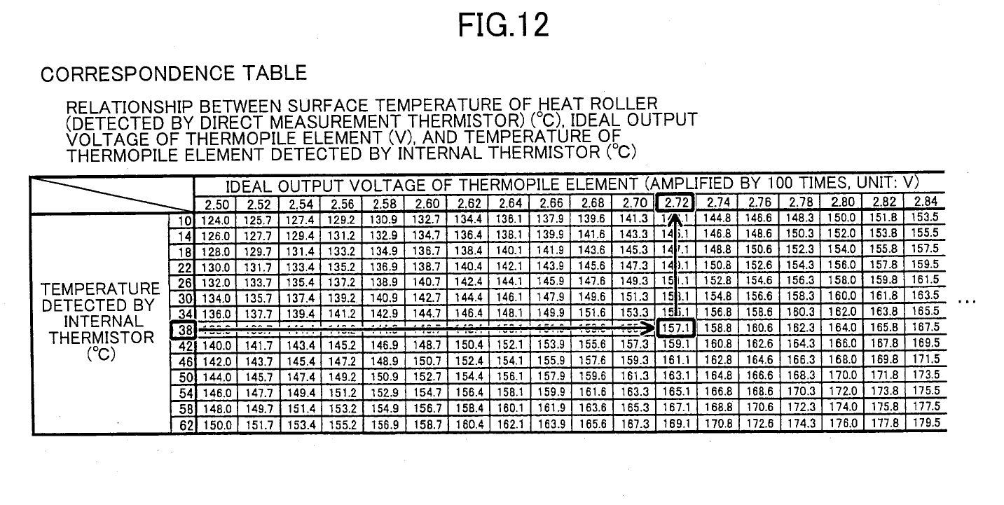

For example, as shown in FIG. 12, if the measurement temperature of the internal thermistor 352 is 38° C. and the output value of the direct measurement thermistor 36 (i.e., the surface temperature of the heat roller 26) is 157.1° C., the CPU 111 can find the ideal output voltage of the thermopile element 350 as 2.72 V.

The “ideal output voltage” of the thermopile element 350 is a value defined in advance as a value expected to be outputted by an average thermopile element.

That is, when the temperature of the thermopile element 350 is 38° C. (the internal thermistor 352) and the temperature of the heat roller 26 detected by the direct measurement thermistor 36 is 157.1° C., the thermopile element 350 is expected to output a voltage of 2.72 V. The ideal output values in the correspondence table may be obtained by calculation using the well-known equation of the Stefan-Boltzmann's Law, which is the equation (1) shown in the first embodiment. Alternatively, it is also possible to perform a measurement experiment of output voltages for a plurality of thermopile elements and adopt an average value of measured values of the experiment.

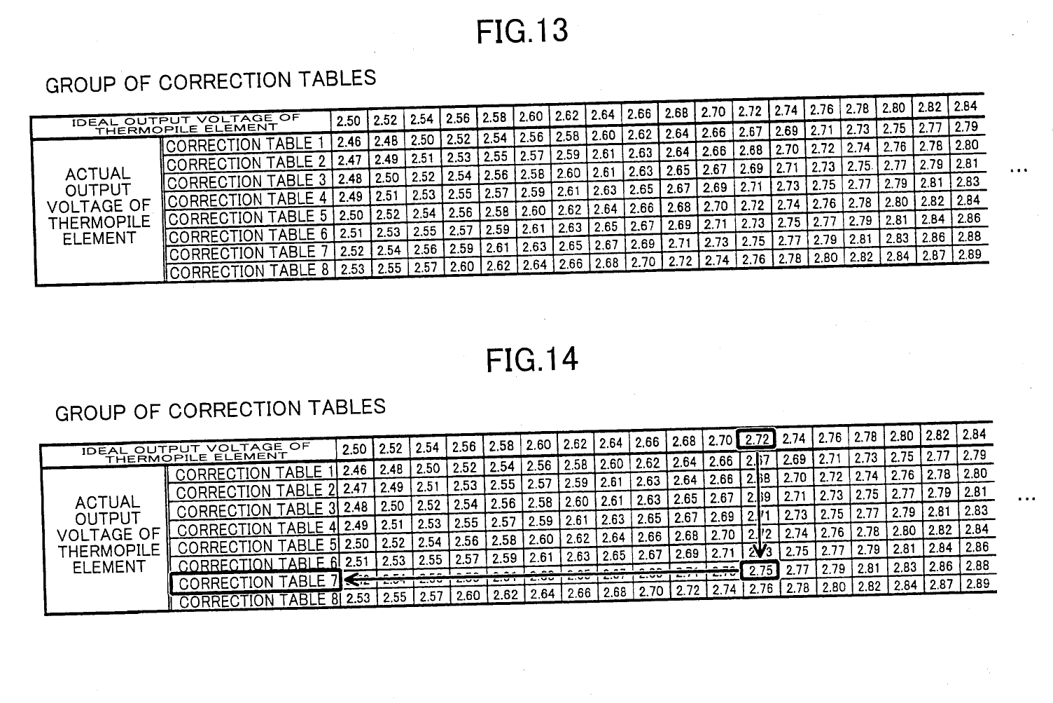

Then, the CPU 111 selects one of correction tables from the group of plurality of correction tables shown in FIG. 13 based upon the ideal output voltage of 2.72 V and the actual output voltage of the thermopile element 350 one stored in the RAM 113.

The group of correction tables defines a relationship between an ideal output voltage and an actual output voltage of the thermopile element 350. In this embodiment, eight correction tables 1 to 8 are prepared according to a degree of shift (error) between the ideal output voltage and the actual output voltage. In a “correction table 5”, the ideal output voltage and the actual output voltage coincide with each other and there is no shift between the two voltages. Note that all the correction tables 1-8 have the common ideal output voltage, whereby a capacity of the ROM 114 is saved.

As shown in FIG. 14, when the ideal output voltage of the thermopile element 350 is 2.72 V and the actual output voltage of the thermopile element 350 is 2.75 V, then the CPU 111 selects a “correction table 7”. The CPU 111 stores the number of the selected correction table in the RAM 113. In this example, the number “7” is stored. Then, the process in S105 ends, and the laser printer 1 enters a “standby” state, where the laser printer 1 can perform printing immediately in response to a print operation instruction from a host apparatus, such as a personal computer.

Even after the laser printer 1 entered the “standby” state, a temperature of the heat roller 26 should be kept within the temperature range suitable for fixing the toner. Therefore, the CPU 111 controls ON/OFF of the halogen lamp 33 whenever necessary in the following manner.

That is, in S106, the CPU 111 obtains an actual output voltage of the thermopile element 350 and a measurement temperature of the internal thermistor 352 and stores them in the RAM 113.

Then, in order to compensate for a variation in a measured value among thermopile elements, the CPU 111 corrects the actual output voltage of the thermopile element 350 using the correction table selected in S105 (S107). More specifically, the CPU 111 reads out the number “17” of the selected correction table from RAM 113, and reads the actual output voltage of the thermopile element 350 from the RAM 113. Then, the CPU 111 obtains an ideal output voltage corresponding to the actual output voltage of the thermopile element 350 from the “correction table 7” stored in the ROM 114.

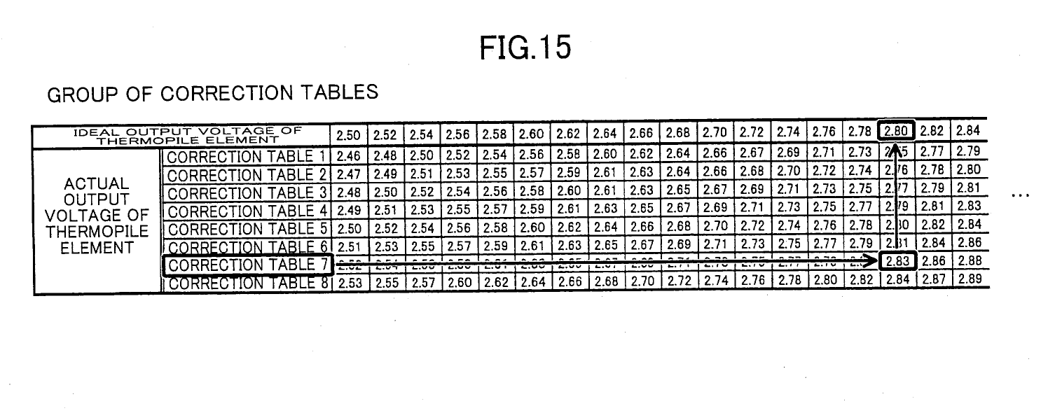

For example, as shown in FIG. 15, when the actual output voltage of the thermopile element 350 is 2.83 V, a corresponding ideal output voltage is 2.80 V according to the selected “correction table 7”. In this manner, the CPU 111 corrects the actual measured value 2.83 into the corresponding ideal output voltage of 2.80 V.

Then, the CPU 111 obtains a surface temperature of the heat roller 26 from the correspondence table of FIG. 11 based on the ideal output voltage of 2.80 V and on the measurement temperature of the internal thermistor 352 (stored in the RAM) (S108). This temperature is determined as a temperature of the heat roller 26.

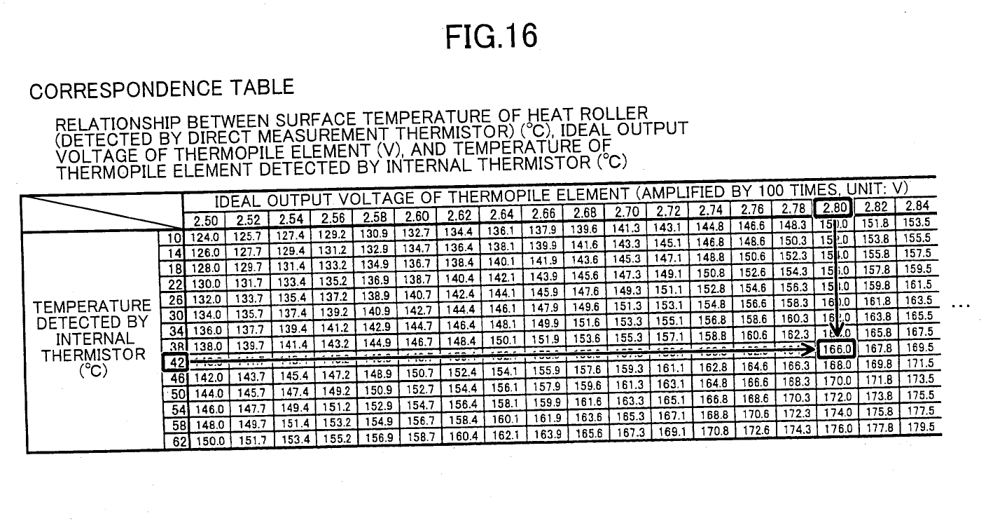

For example, as shown in FIG. 16, when the ideal output voltage is 2.80 V and the measurement temperature of the internal thermistor 352 is 42° C., then the surface temperature of the heat roller 26 is determined as 166.0° C.

The surface temperature of the heat roller 26 (166.0° C.) determined in this manner is used for temperature control of the heat roller 26. A temperature range suitable for fixing a toner is set in advance. Thus, the CPU 111 turns OFF the halogen lamp 33 when the surface temperature of the heat roller 26 has exceeded an upper limit of the temperature range, and turns ON the halogen lamp 33 when the surface temperature of the heat roller 26 has fallen below a lower limit of the temperature range (S109).

By repeating the processes of S106 to S109, the surface temperature of the heat roller 26 can be kept within the predetermined temperature range.

As described above, the fixing device 19 of the present embodiment can perform the temperature control of the heat roller 26 accurately and appropriately by correcting an output value of the thermopile 35. Therefore, the fixing device 19 can fix the toner images on the recording sheet 3 reliably while saving energy consumption. This effect is particularly effective for a color printer that uses a colored toner because a temperature range to fix appropriately the colored toner is narrow.

Moreover, a time required for the warm-up can also be reduced. Thus, the laser printer 1 can enter the standby state in a short time after the power is turned ON.

In addition, in this embodiment, the direct measurement thermistor 36 detects a temperature of the heat roller 26 at a portion that does not contact the recording sheet 3 Thus, even if a large number of recording sheets 3 go through the fixing device 19 over a long period of time, the portion is never worn out by the recording sheets 3. Therefore, a measurement error of the direct measurement thermistor 36 due to such wear is prevented, so that an output value of the thermopile 35 can be corrected appropriately.

In addition, the fixing device 19 of this embodiment uses a contact sensor as the direct measurement thermistor 36. Thus, a measured value of the direct measurement thermistor 36 is less likely affected by a secular change of the surface of the heat roller 26 (in particular, a secular change of an emissivity) compared with when a non-contact infrared ray sensor or the like is used. Therefore, it is possible to measure the temperature of the heat roller 26 accurately using the direct measurement thermistor 36 over a long period of time.

The thermopile 35 of the present embodiment is highly sensitive and capable of responding at a high speed, whereby the temperature of the heat roller 26 can be controlled accurately, and the fixing device 19 can fix a toner image reliably while saving power consumption.

In addition, in this embodiment, variation in output values among thermopile elements is corrected by using a relationship between actual output values and ideal output values of the thermopile elements. Therefore, highly accurate temperature measurement can be performed.

According to this construction, variation in infrared ray emissivity among heat rollers (26) can also be corrected together with the variation in the output values among the thermopile elements. Therefore, it is unnecessary to provide a special mechanism for measuring an emissivity of the heat roller 26 in the fixing device 19 or the laser printer 1. It is also unnecessary to measure an emissivity of the heat roller 26 accurately to adjust the heat roller 26 based upon the measured emissivity at the time when the fixing device 19 is manufactured.

Further, in this embodiment, the correspondence table and the correction tables are stored in the ROM 114 in advance, whereby the processing of correction can be performed only by applying measured values to the correction tables. Therefore, a load exerted on the CPU 11 can be reduced.

Moreover, in this embodiment, a correction table is selected after a temperature of the heat roller 26 has raised and before the recording sheet 3 comes into contact with the heat roller 26. That is, the laser printer 1 in the “warm-up state” does not start a print operation even if a print operation instruction is received from a host apparatus, and waits until the laser printer 1 enters the “standby state”. The laser printer 1 enters the “standby” state after the temperature of the heat roller 26 has been sufficiently raised, and a correction table has been selected. Then, the laser printer 1 starts a print operation, and a first recording sheet 3 passes through the sheet conveying path and brought into contact with the heat roller 26.

Because a correction table is selected before the recording sheet 3 is supplied to the fixing device 19, heat of the heat roller 26 is never deprived by the recording sheet 3 at a stage of the selection of a correction table. Therefore, an appropriate correction table can be selected without being affected by a decrease in a temperature in a contact area of the recording sheet 3 of the heat roller 26. It is possible to correct an output value of the thermopile 35 appropriately and the temperature control of the heat roller 26 can be performed accurately.

In this embodiment, an output value of the thermopile 35 is corrected based upon the voltage value outputted during the heat roller 26 is actually used at high temperature (toner is fixed). Therefore, the correction can be performed more appropriately, errors can be reduced, and a measurement accuracy can be further improved compared with the structure in which the correction is performed before the temperature of the heat roller 26 rises.

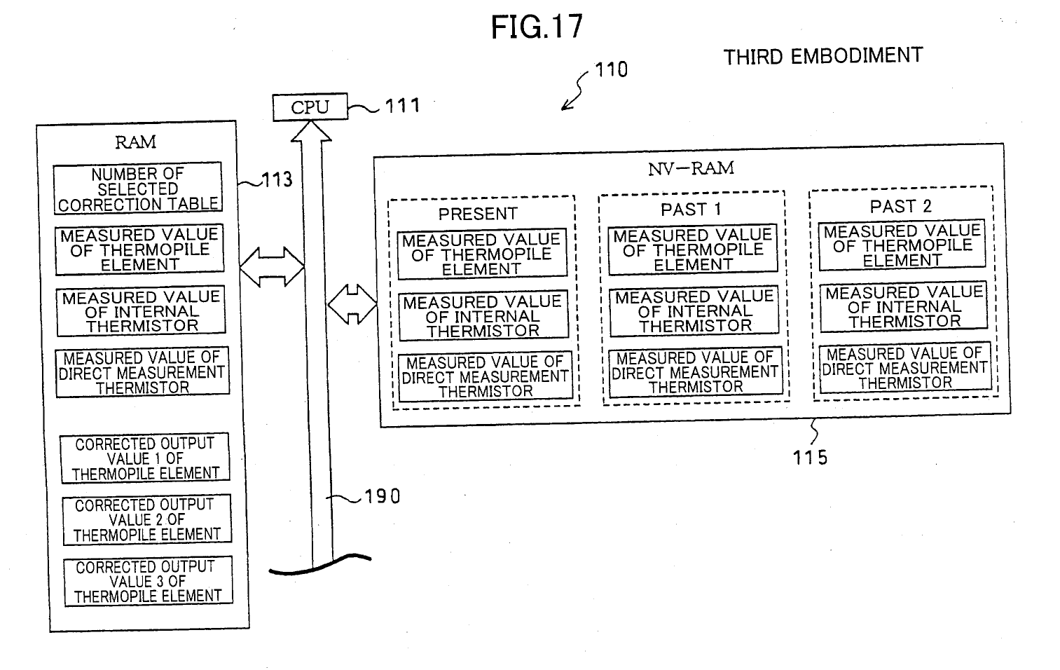

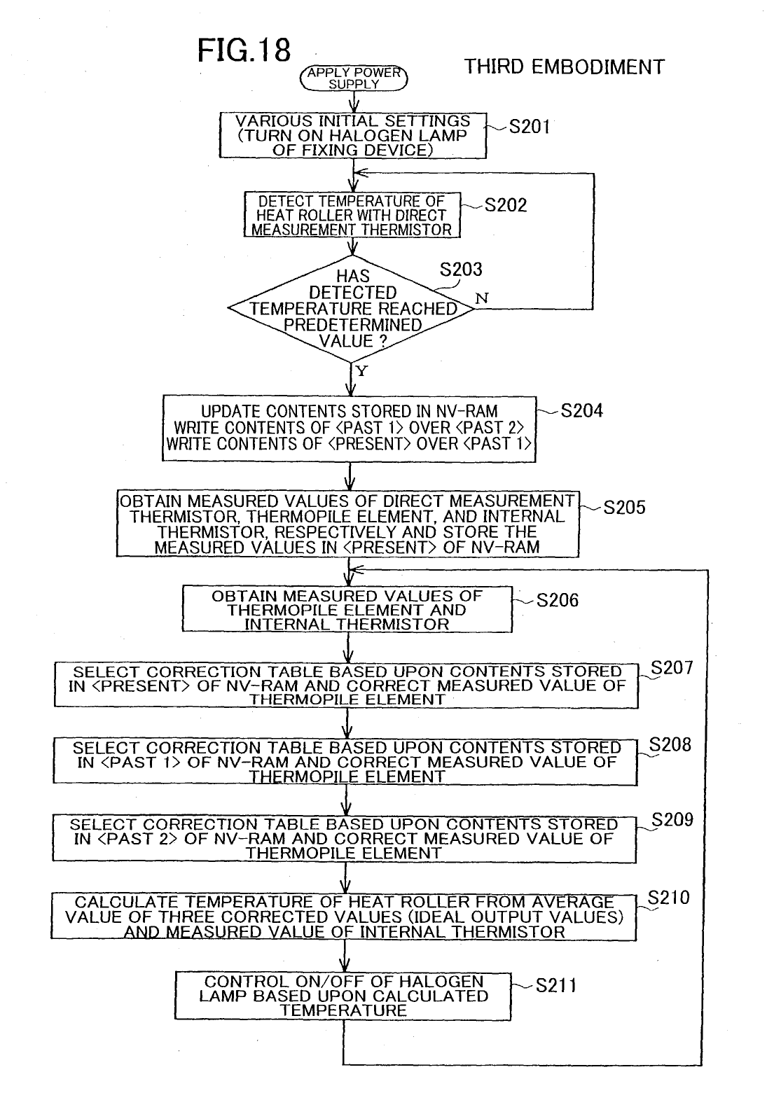

Next, a third embodiment of the present invention will be described with reference to FIGS. 17 and 18.

Since structures of the laser printer 1 and the fixing device 19 in the third embodiment are the same as those in the second embodiment, a description thereof will be omitted.

The third embodiment is characterized in that a plurality of sets of output values of the direct measurement thermistor 36, the thermopile element 350, and the internal thermistor 352 are stored in the NV-RAM 115.

As shown in FIG. 17, in the third embodiment, the NV-RAM 115 stores three sets of output values (measured values) of the direct measurement thermistor 36, the thermopile element 350, and the internal thermistor 352 for <present>, <past 1>, and <past 2>. In the <present>, a set of output values of this time is stored. In the <past 1>, a set of output values of last time is stored. In the <past 2>, a set of output values of before last is stored.

A main control process of the third embodiment will be described with reference to a flowchart of FIG. 18. Processes for heating the heat roller 26 to a predetermined temperature (S201 to S203) after a power was turned ON are the same as these in S101 to S103 of the second embodiment.

In S204, the CPU 111 updates contents of the NV-RAM 115. In this update, the set of-output values stored in the <past 1> is written in the <past 2>. As a result, the set of output values having been stored in the <past 2> is erased. Next, the set of output values stored in the <present> is written in the <past 1>.

Next, in S205, the CPU 111 obtains the output values of the direct measurement thermistor 36, the thermopile element 350, and the internal thermistor 352 and writes these values in the <present> of the NV-RAM 115. In this way, one measurement is completed.

Thereafter, the laser printer 1 enters the “standby” state and waits for a print operation instruction. Note that, in the third embodiment, unlike the second embodiment, a correction table is selected after the laser printer 1 enters the “standby” state.

After the laser printer 1 enters the “standby” state, the CPU 111 obtains in S206 actual output values of the thermopile element 350 and the internal thermistor 352 and stores them in the RAM 113. This is completely the same as S106 of the second embodiment.

Then, in S207, the CPU 111 correct the actual output value of the thermopile element 350 based upon the output values stored in the <present> of the NV-RAM 115.

Specifically, the CPU 111 obtains an ideal output value of the thermopile element 350 using the correspondence table based on the output value of the direct measurement thermistor 36 (temperature of the heat roller 26) and the output value of the internal thermistor 352, which are stored in the <present> of the NV-RAM 115. This is the same as S105 of the second embodiment except that values stored in the NV-RAM 115 rather than the RAM 113 are used as the output value of the direct measurement thermistor 36 and the output value of the internal thermistor 352.

Then, the CPU 111 selects one of the correction tables 1-8 based on the ideal output value and on the output value of the thermopile element 350 stored in the <present> of the NV-RAM 115. This is also the same as S105 of the second embodiment except that values stored in the NV-RAM 115 rather than the actual output value of the thermopile element 350 stored in the RAM 113 are used.

Next, the CPU 111 corrects the actual value of the thermopile element 350 stored in the RAM 113 into an ideal output value using the selected correction table. This process is completely the same as the process of S107 of the second embodiment. The ideal output value obtained in this way is stored in a storage area secured in the RAM 113 appropriately.

This correction process (selecting a correction table and correcting an output value into an ideal output value using the selected correction table) is also performed based upon the output values stored in the <past 1> of the NV-RAM 115 (S208), and is performed based on the output values stored in the <past 2> of the NV-RAM 115 (S209). Resultant ideal output values are stored in the appropriate storage area of the RAM 113.

As a result, the three ideal output values are stored in the RAM 113, each obtained based on the output value of the thermopile element 350 stored in the RAM 113 and a corresponding one of the data sets in the <present>, the <past 1>, and the <past 2>in the NV-RAM 115.

Next, in S210, the CPU 111 calculates an average of the three ideal output values and obtains a surface temperature of the heat roller 26 in accordance with the correspondence table of FIG. 11 from the average ideal output value and the actual output value of the internal thermistor 352 stored in the RAM 113. This temperature is determined as the surface temperature of the heat roller 26. In the next S211, the CPU 111 controls ON/OFF of the halogen lamp 33 based upon the temperature obtained in S210 and returns to S206.

As described above, in this embodiment, the actual output value of the thermopile element 350 is corrected using output values of three times rather than one time of measurement (the number of times of turning ON the power supply). Thus, influence of an error for each time of measurement is kept small, and an output value of the thermopile element 350 can be corrected more accurately and appropriately.

In addition, since oldest measured values are erased and new measured values are stored for each time of measurement, correction can be performed which also copes with an influence exerted on an output value by a secular change of the heat roller 26 (change in an emissivity). Therefore, an accuracy of temperature measurement of the heat roller 26 less likely decreases over a long period of time, and appropriate temperature control can be performed.

In the third embodiment, measured values of the latest three times of measurement of the <present>, the <past 1>, and the <past 2>are used. However, the present invention is not limited to this, and for example, only measured values of two times of measurement of the <present> and the <past> may be used or, on the contrary, measured values of more than three times of measurement, such as the <present>, the <past 1>, the <past 2>, the <past 3>, . . . may be used.

In general, if measured values of a larger number of times of measurement is used to find an average of the ideal output values, an influence of errors for each time of measurement can be further decreased.

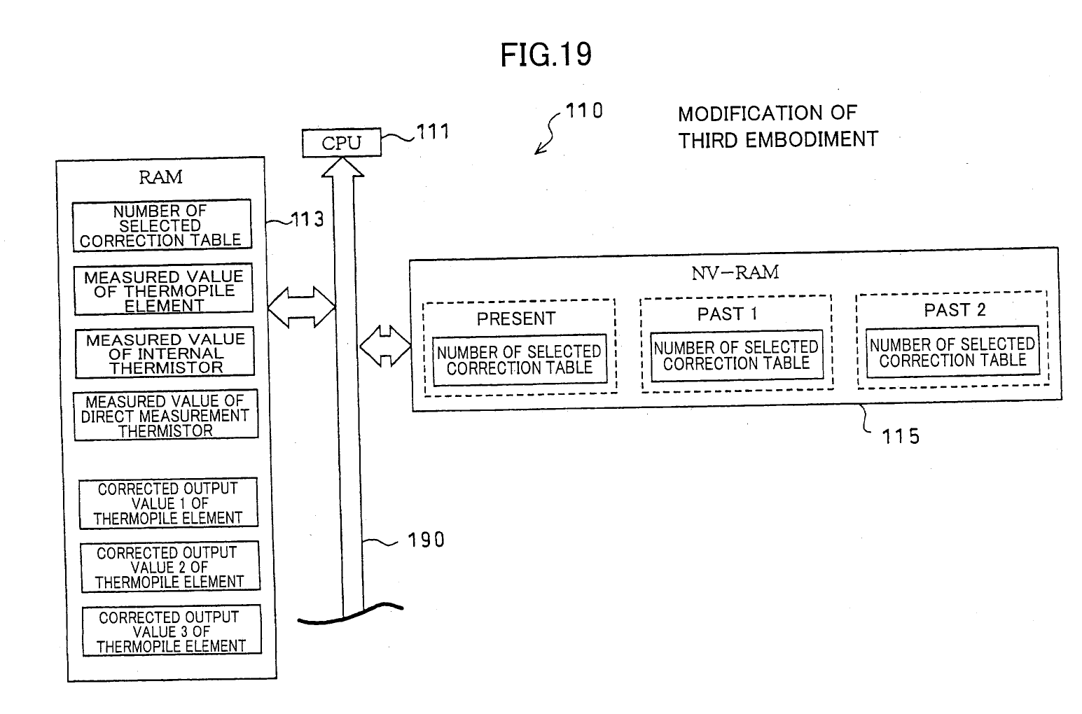

FIG. 19 shows a modification of the third embodiment. In this modification, numbers of selected correction tables are stored in the <present>, the <past 1>, and the <past 2> of the NV-RAM 115 instead of measured values.

Specifically, the CPU 111 obtains, in S205 of the third embodiment, output values of the direct measurement thermistor 36, the thermopile element 350, and the internal thermistor 352, and stores the output values in the RAM 113. The CPU 111 selects a correction table in the same manner as the second embodiment using the output values and stores a number of the selected correction table in the <present> of the NV-RAM 115.

Then, in S207 to S209, the CPU 111 reads out numbers of the correction tables from the <present>, the <past 1>, and the <past 2> of the NV-RAM 115, and obtains three ideal output values corresponding to the actual output value of the thermopile element 350 using the correction tables of these numbers. This modification can provide the same effect as the third embodiment. Moreover, according to this modification, since only the numbers of selected correction tables need to be stored in the NV-RAM 115, inexpensive NV-RAM 115 with a small storage capacity can be used.

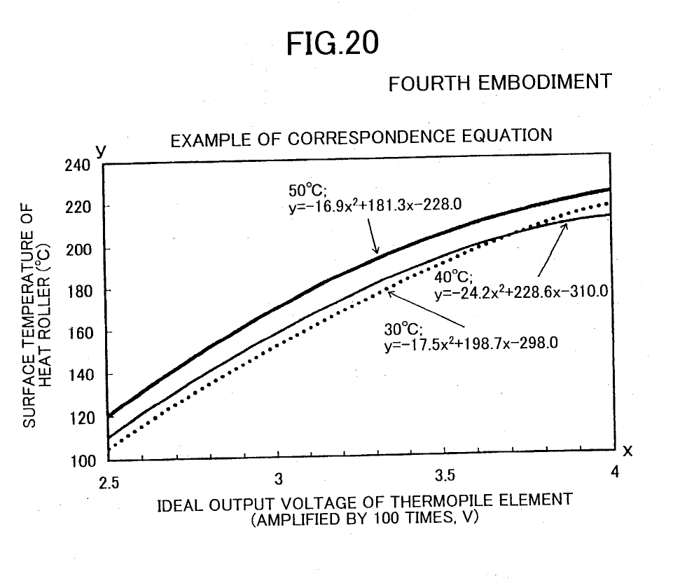

Next, a fourth embodiment of the present invention will be described with reference to FIGS. 20 to 22.

Since structures of the laser printer 1 and the fixing device 19 in the fourth embodiment are also the same as those in the second embodiment, a description thereof will be omitted.

The fourth embodiment is characterized in that correspondence equations and correction equations are used instead of the correspondence table and the correction tables.

The correspondence equations of the fourth embodiment are shown in FIG. 20. Each correspondence equation represents a relationship among a surface temperature of the heat roller 26, an ideal output voltage of the thermopile element 350, and a measurement temperature of the internal thermistor 352 as in the correspondence table (FIG. 11) but by using an approximation of a quadratic curve. In an example of FIG. 20, relationships between a surface temperature y of the heat roller 26 and an ideal output voltage x of the thermopile element 350 are shown for when a temperature of the thermopile element 350 (measurement temperature of the internal thermistor 352) is 30° C., 40° C., and 50° C.

These correspondence equations are stored in the ROM 114. More specifically, respective coefficients (a, b, and c) of a relation shown in a form of y=ax²+bx+c in FIG. 20 are stored in a table format for the cases in which the measurement temperature of the internal thermistor 352 is 30° C., 40° C., and 50° C., respectively.

Although the cases in which the temperature of the thermopile element 350 (measurement temperature of the internal thermistor 352) is 30° C., 40° C., and 50° C. are illustrated in FIG. 20, the present invention is not limited to this. For example, if correspondence equations are prepared at intervals of 4° C. of the measurement temperature of the internal thermistor 352, more accurate measurement is possible.

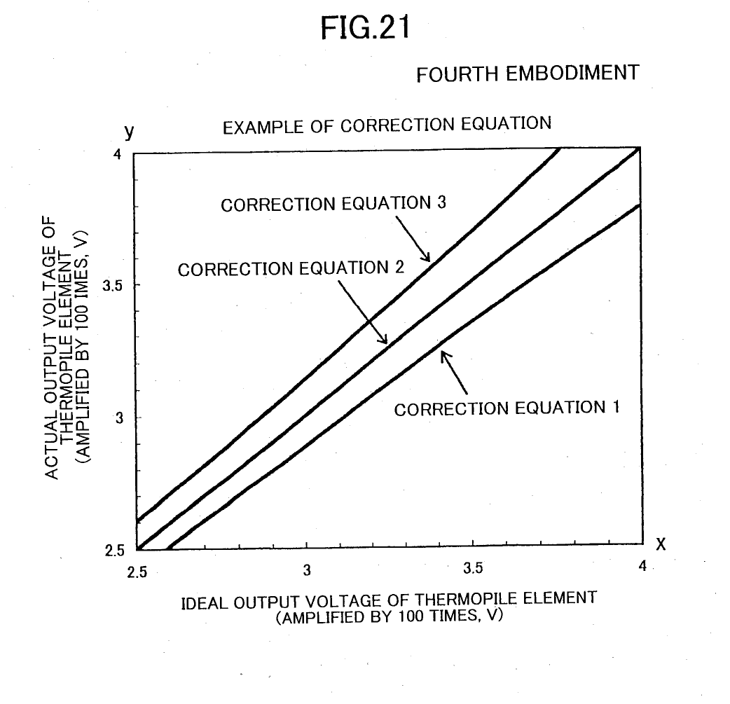

FIG. 21 shows the correction equations of the fourth embodiment. Each correction equation represents a relationship between an ideal output voltage and an actual output voltage of the thermopile element 350 as in the group of correction tables (FIG. 13), but by using an approximation of a quadratic curve.

Each of three lines (correction equations 1 to 3) corresponds to one correction table. Needless to say, more correction equations may be used.

The correction equations are stored in the ROM 14. Although FIG. 21 does not show contents of a specific correction equation, the correction equations 1 to 3 are represented in the form of y=ax²+bx+c in the same manner as the correspondence equations, and values of the respective coefficients (a, b, and c) are stored in a table format in association with numbers of the correction equations.

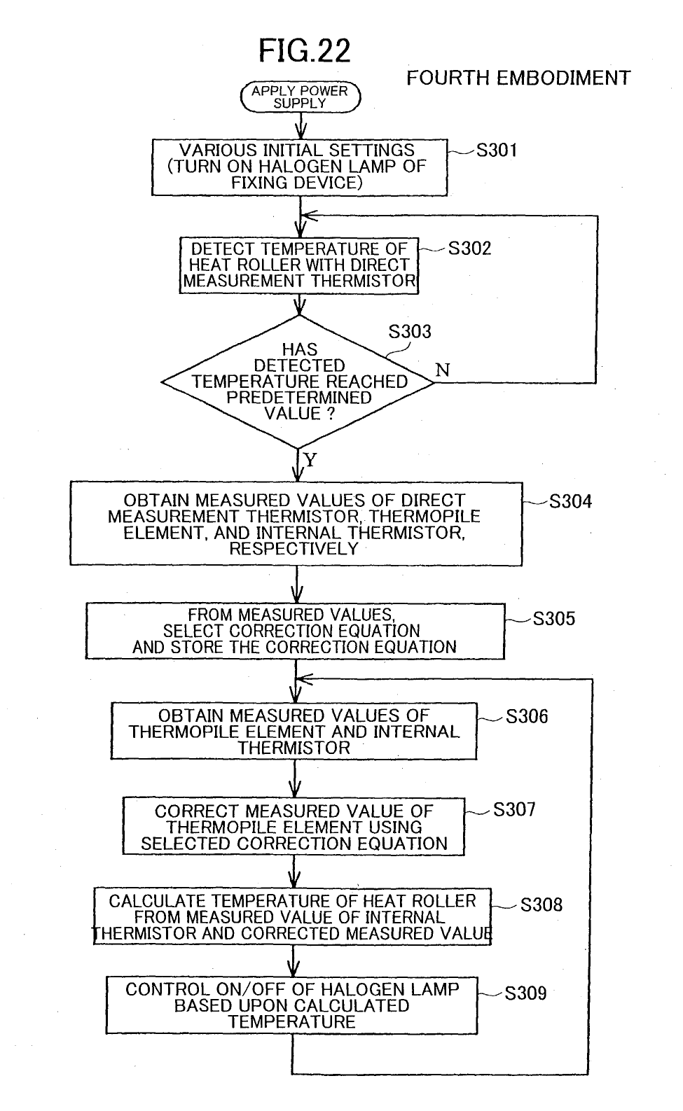

Next, a main control process of the fourth embodiment will be described with reference to a flowchart of FIG. 22.

The main control process in the fourth embodiment is the same as the second embodiment except that the correspondence equation is used instead of the correspondence table and the correction equation is used instead of the correction table, respectively.

Processes in S301 to S304 are the same as S101 to S104 of the second embodiment. In the processes of S301 to S304, the heat roller 26 is heated to a temperature suitable for fixing a toner, and output values of the thermopile element 350, the internal thermistor 352, and the direct measurement thermistor 36 are stored in the RAM 113.

Then, in S305, a correction equation is selected in a method described below. First, the CPU 111 calculates an ideal output value of the thermopile element 350 based upon the output value of the direct measurement thermistor 36 and the output value of the internal thermistor 352 by using one of the correspondence equations of FIG. 20.

Next, the CPU 111 selects one of the correction equations 1 to 3 closest to one representing a relationship between the obtained ideal output value and the actual measured value of the thermopile element 350. The selected correction equation is stored in the RAM 113.

In S306, the CPU 111 obtains an output value of the thermopile element 350 and an output value of the internal thermistor 352. Next, in S307, the CPU 111 corrects the actual output value of the thermopile element 350 obtained in S306 into an ideal output value using the correction equation selected in S305. In S308, the CPU 111 calculates a temperature of the heat roller 26 using the correspondence equations (FIG. 20) based on the ideal output value and the output value of the internal thermistor 352. In step S309, ON/OFF of the halogen lamp 33 is controlled based upon the calculated temperature.

In this way, an output value of the thermopile 35 is corrected taking into account both of variation among thermopiles and variation among infrared ray emissivity of heat rollers. Therefore, an accurate temperature of the heat roller 26 can be obtained, and temperature control of the heat roller 26 can be performed accurately. Consequently, the fixing device 19 can fix a toner on the recording sheet 3 reliably while saving energy consumption. In addition, it is unnecessary to store a one-to-one relationship of respective values in a table format concerning a correspondence relationship and a correction relationship, an inexpensive ROM with a small storage capacity can be used as the ROM 114.

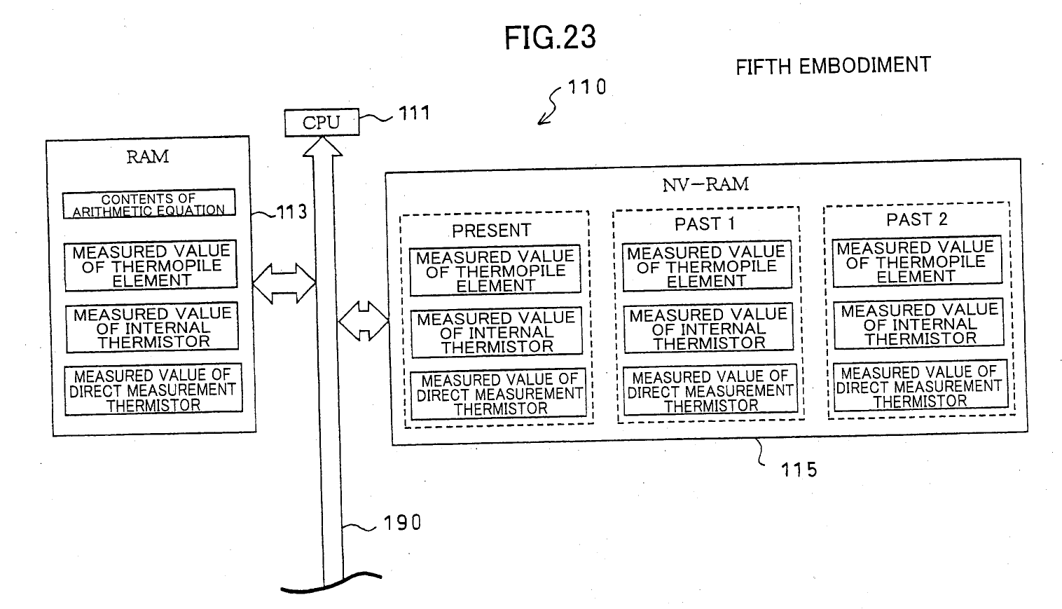

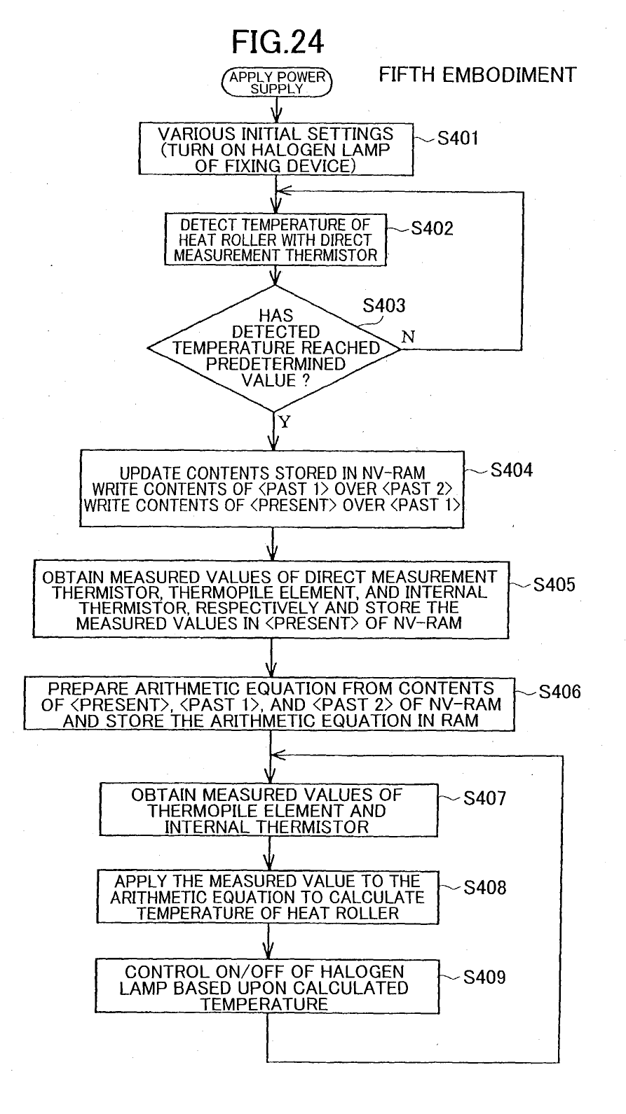

Next, a fifth embodiment of the present invention will be described with reference to FIGS. 23 and 24. Since structures of the laser printer 1 and the fixing device 19 in the fifth embodiment are the same as those in the second embodiment, a description thereof will be omitted.

In this embodiment, as shown in FIG. 23, a plurality of sets of output values of the direct measurement thermistor 36, the thermopile element 350, and the internal thermistor 352 are stored in the NV-RAM 115 in advance as in the third embodiment. An appropriate arithmetic equation is prepared from the plurality of sets of output values, and a surface temperature of the heat roller 26 is calculated using this arithmetic equation.

A main control process in this embodiment will be described in accordance with the flowchart of FIG. 24.

In S401 to S405, the CPU 111 performs the same processes as in S201 to S205 of the third embodiment. That is, the heat roller 26 is heated to a temperature suitable for fixing a toner. Three sets of output values of the latest three times of measurement of the thermopile element 350, the internal thermistor 352, and the direct measurement thermistor 36 are stored in the <present>, the <past 1>, and the <past 2> of the NV-RAM 115, respectively.

In S406, the CPU 111 prepares an arithmetic equation using the three sets of output values stored in the NV-RAM 115. There are various methods of preparing this arithmetic equation. For example, an arithmetic equation of y=ax₁+bx₂+c (a, b, and c are unknown numbers) can be used. The output values of the thermopile element 350, the internal thermistor 352, and the direct measurement thermistor 36 stored in the <present>, the <past 1>, and the <past 2> of the NV-RAM 115, are substituted for x₁, x₂, and y of this arithmetic equation, respectively. In this way, three equations showing relationships among a, b, and c can be obtained. A solution to (a, b, c) can be found by simultaneously setting up these equations and solving them. Then, the solution of (a, b, c) is stored in the RAM 113.

Thereafter, the laser printer 1 enters the “standby” state. After obtaining output values of the thermopile element 350 and the internal thermistor 352 in S407, the CPU 111 finds the temperature y of the heat roller 26 by substituting the output values of the thermopile element 350 and the internal thermistor 352 for x₁ and x₂ in the arithmetic equation in S408, respectively. In S409, the CPU 111 controls ON/OFF of the halogen lamp 33 based on the calculated temperature y of the heat roller 26.

As described above, according to the present embodiment, an output value of the thermopile 35 can be corrected taking into account both of variation among thermopiles and variation in infrared ray emissivity among heat rollers. Consequently, an accurate temperature of the heat roller 26 can be obtained, and the temperature control of the heat roller 26 can be performed with a high accuracy. Therefore, the fixing device 19 can fix a toner on the recording sheet 3 reliably while saving energy consumption.

Moreover, a process of correcting an actual output value of the thermopile element 350 into an ideal output value thereof can be omitted, and a temperature of the heat roller 26 is directly calculated using an arithmetic equation from an output value of the thermopile element 350 and a measurement temperature of the internal thermistor 352. Therefore, a processing load and processing time of the CPU 111 can be reduced, and accurate temperature control of the heat roller 26 can be performed. In addition, since it is unnecessary to store a correspondence relationship or a correction relationship in the form of a table or an equation, an inexpensive ROM with a small storage capacity can be used as the ROM 114.

Although the NV-RAM 115 of the present embodiment stores the three sets of output values for the <present>, the <past 1>, and the <past 2>, it is possible to store four or more sets of output values. In this case, it is possible to determine the arithmetic equation using, for example, the method of least squares.

Since the laser printer 1 of the first to fifth embodiments includes the fixing device 19 as described above, the temperature control of the heat roller 26 can be performed with a high accuracy. Therefore, energy consumption and the warm-up time of the laser printer 1 can be reduced, and a toner can be fixed reliably and easily.

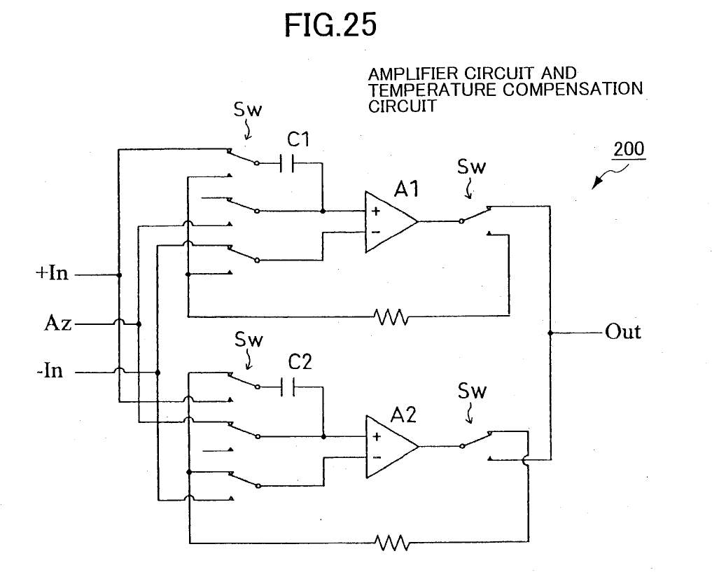

Next, an amplifier circuit 200 commonly used in the first to fifth embodiments will be described with reference to FIG. 25.

This amplifier circuit 200 is for amplifying an output voltage of the thermopile element 350 which is usually as low as several tens mV. If an amplifier circuit is constituted solely by an OP amplifier, an offset drift caused by a temperature change (or an offset drift caused by a secular change) adversely affects a measurement accuracy significantly. In view of this point, in these embodiments, the amplifier circuit 200 of FIG. 25 is used.

Output from the thermopile element 350 is amplified and inputted in +In and −In in the amplifier circuit 200 The amplifier circuit 0.200 converts a direct current outputted by the thermopile element 350 into an alternating current with analog switches Sw, AC-amplifies the alternating current with two OP amplifiers A1 and A2, and then converts the AC-amplified alternating current into a direct current again with the analog switches Sw. The amplifier circuit 200 is a chopper type amplifier. Note that Az represents auto zero.

While one OP amplifier A1 is amplifying a voltage, the other OP amplifier A2 cancels an offset (zero adjustment) using a capacitor C2. When the analog switch Sw is switched over, the roles of the two OP amplifiers A1 and A2 are reversed. That is, the operating OP amplifier A1 cancels an offset thereof using the capacitor C1 and the OP amplifier A2 amplifies a voltage.

As described above, because the amplifier circuit 200 provides an amplifier circuit for amplifying a faint electric power outputted from the thermopile 35 and a temperature compensation circuit for canceling a temperature drift of this amplifier circuit, the temperature drift of the amplifier circuit due to temperature rise of the heat roller 26 is compensated. Therefore, the output of the thermopile 35 can be amplified appropriately and the temperature of the heat roller 26 can be controlled accurately.

In addition, since the amplifier circuit 200 is constituted as an integral semiconductor (IC) including the two OP amplifiers A1 and A2 and the analog switches Sw, compact-sized fixing device 19 and laser printer 1 can be realized.

Moreover, since the amplifier circuit and the temperature compensation circuit are constituted by the chopper amplifier (200) in the fixing device 19, compensation of a temperature drift can be performed appropriately.

While some exemplary embodiments of this invention have been described in detail, those skilled in the art will recognize that there are many possible modificaitons and variations which may be made in these exemplary embodiments while yet retaining many of the novel features and advantages of the invention.

For example, in the above-mentioned first to fifth embodiments, the heat roller 26 and the pressure roller 27 are used as fixing means. However, the present invention may be applied to any form of fixing means including a belt-type heat member and a roller-type pressing member, a roller-type heat member and a belt-type pressing member, or a belt-type heat member and a belt-type pressing member.

In the above-mentioned embodiments, the present invention is applied for the fixing device 19 of the laser printer 1. However, the present invention could be applied for, for example, a laminator or the like for thermally fixing a film.

In the above-mentioned embodiments, the fixing device 19 with the halogen lamp 33 incorporated in the heat roller 26 is used. However, a fixing device using an IH (induction heating) system may be used. This type of fixing device includes an electromagnet provided in an axial direction inside a heat roller, and a magnetic field emitted from the electromagnet heats up the heat roller.

An infrared ray sensor other than a thermopile may be used.

In addition, in the above-mentioned embodiments, a temperature of the heat roller 26 is measured. However, since a temperature of the pressure roller 27 that receives heat from the heat roller 26 is correlated to the temperature of the heat roller 26, the temperature of the pressure roller 27 may be measured.

Further, in the above-mentioned second to fifth embodiments, the selection of a correction table, the selection of a correction equation, or the preparation of an arithmetic equation is performed when the power of the laser printer 1 is turned ON. However, the present invention is not limited to this.

For example, the laser printer 1 may enter a “sleep” state and turns OFF the halogen lamp 33 to save power when no print operation instruction has been received for a long period of time. Then, when the laser printer 1 receives a print operation instruction in the “sleep” state, the halogen lamp 33 is immediately turned ON to bring the laser printer 1 into the “standby” state. The selection of a correction table or the like may be performed when the laser printer 1 enters the “standby” state from the “sleep” state in this manner.

What is claimed is:

1. A temperature calculating method for calculating a surface temperature of a fixing unit that thermally fixes a fixed medium onto a fixing medium, comprising the steps of:
detecting a level of an electric signal from an infrared ray sensor that is provided in a non-contact manner with the surface of the fixing unit, and receives infrared rays emitted from the surface of the fixing unit, the level corresponding to an amount of the received infrared rays;
detecting a temperature of the infrared ray sensor by using a temperature sensor provided to the infrared ray sensor; and
calculating the surface temperature of the fixing unit based on the level of the electric signal outputted from the infrared ray sensor and the temperature of the infrared ray sensor detected by the temperature sensor using an equation:
T={(k₁·P+k₂+T₀⁴)/ε}^{1/4}
wherein
T is the surface temperature of the fixing unit;
P is the level of the electric signal outputted from the infrared ray sensor;
k₁ is a constant specific to the infrared ray sensor;
k₂ is a constant specific to the infrared ray sensor;
T₀ is the temperature of the infrared ray sensor detected by the temperature sensor; and
ε is an emissivity of infrared rays of the fixing unit.

2. A program for calculating a surface temperature of a fixing unit that thermally fixes a fixed medium onto a fixing medium, the program comprising the programs of:
detecting a level of an electric signal from an infrared ray sensor that is provided in a non-contact manner with the surface of the fixing unit, and receives infrared rays emitted from the surface of the fixing unit, the level corresponding to an amount of the received infrared rays;
detecting a temperature of the infrared ray sensor by using a temperature sensor provided to the infrared ray sensor; and
calculating the surface temperature of the fixing unit based on the level of the electric signal outputted from the infrared ray sensor and the temperature of the infrared ray sensor detected by the temperature sensor using an equation:
T={(k₁P+k₂+T₀⁴)/ε}^{1/4}
wherein
T is the surface temperature of the fixing unit;
P is the level of the electric signal outputted from the infrared ray sensor;
k₁ is a constant specific to the infrared ray sensor;
k₂ is a constant specific to the infrared ray sensor;
T⁰ is the temperature of the infrared ray sensor detected by the temperature sensor; and
ε is an emissivity of infrared rays of the fixing unit.

3. A fixing device comprising:
a fixing unit that thermally fixes a fixed medium onto a fixing medium;
an infrared ray sensor provided in a non-contact manner with a surface of the fixing unit, the infrared ray sensor receiving infrared rays emitted from the surface of the fixing unit and outputting an electric signal of a level corresponding to an amount of the received infrared rays;
a temperature sensor that detects a temperature of the infrared ray sensor; and
a temperature detection unit that detects a surface temperature of the fixing unit based both on the level of the electric signal outputted from the infrared ray sensor and on the temperature of the infrared ray sensor detected by the temperature sensor using an equation:
T={(k₁·P+k₂+T₀⁴)/ε}1/4
wherein
T is the surface temperature of the fixing unit;
P is the level of the electric signal outputted from the infrared ray sensor;
k₁ is a constant specific to the infrared ray sensor;
k₂ is a constant specific to the infrared ray sensor;
T₀ is the temperature of the infrared ray sensor detected by the temperature sensor; and
ε is an emissivity of infrared rays of the fixing unit.

4. The fixing device as claimed in claim 3, further comprising a storing unit that stores a table, the table indicating relationships among the surface temperature T, the level P, and the temperature T₀, the relationships being determined based on the equation:
T={(k₁·P+k₂+T₀⁴)/ε}^{1/4}
wherein the temperature detection unit detects the surface temperature T by reading the surface temperature T from the table stored in the storing unit.

5. The fixing device as claimed in claim 3, wherein the infrared ray sensor is a thermopile element.

6. The fixing device as claimed in claim 3, wherein the infrared ray sensor is provided with a filter for cutting infrared rays of a wavelength area that tend to be absorbed by water vapor.

7. The fixing device as claimed in claim 6, wherein the filter cuts infrared rays of wavelengths shorter than or equal to 2.0 μm.

8. The fixing device as claimed in claim 6, wherein the filter cuts infrared rays of wavelengths shorter than or equal to 8.0 μm.

9. A fixing device comprising:
a fixing unit that contacts a fixing medium and heats the fixing medium;
an infrared ray detection unit provided in a non-contact manner with a surface of the fixing unit, the infrared ray detection unit receiving infrared rays emitted from the surface of the fixing unit and outputting an electric signal of an output value corresponding to an amount of the received infrared rays;
a first temperature detection unit that detects an actual temperature of the fixing unit;
a correction unit that corrects the output value into an ideal output value based on the temperature detected by the first temperature detection unit; and
a second temperature detection unit that detects a temperature of the fixing unit based on the ideal output value.

10. The fixing device as claimed in claim 9, further comprising a temperature control unit that controls the temperature of the fixing unit based on the temperature detected by the second temperature detection unit.

11. The fixing device as claimed in claim 9, wherein the first temperature detection unit detects the temperature of the surface of the fixing unit at a region outside an area that contacts the fixing medium.

12. The fixing device as claimed in claim 9, wherein the first temperature detection unit is a contact sensor.

13. The fixing device as claimed in claim 9, wherein the infrared ray detection unit is a thermopile.

14. The fixing device as claimed in claim 9, wherein the correction unit includes:
an internal temperature detection unit that detects a temperature of the infrared ray detection unit; and
a storing unit that stores relation data indicating relationships among the ideal output value, the temperature detected by the internal temperature detection unit, and the actual temperature of the fixing unit,
wherein the second temperature detection unit detects the temperature of the fixing unit based on the output value and the relation data.

15. The fixing device as claimed in claim 14, wherein the relation data is a correspondence table among the ideal output value, the temperature detected by the internal temperature detection unit, and the actual temperature of the fixing unit,
wherein the storing unit further stores a group of correction tables showing different relationships between the output value and the ideal output value; and
the second temperature detection unit includes:
a first determining unit that determines a first ideal output value corresponding to a first output value based on the temperature of the fixing unit detected by the first temperature detection unit as the actual temperature, a first temperature detected by the internal temperature detection unit, and the correspondence table;
a selecting unit that selects a correction table from the group of correction tables, the correction table corresponding to a relationship between the first ideal output value and the first output value;
a second determining unit that determines a second ideal output value corresponding to a second output value by using the selected correction table; and
a third determining unit that determines a temperature of the fixing unit from the correspondence table based on the second ideal output value and a second temperature detected by the internal temperature detection unit as the temperature of the fixing unit.

16. The fixing device as claimed in claim 15, wherein the storing unit stores at least two sets of history data relating to the first output value of the infrared ray detection unit, the temperature detected by the first temperature detection unit, and the first temperature detected by the internal temperature detection unit;
the second determining unit determines a plural of the second ideal output values based on each set of the history data stored in the storing unit; and
the third determining unit determines a temperature of the fixing unit from the correspondence table based on an average value of the plural of the second ideal output values and the second temperature detected by the internal temperature detection unit as the temperature of the fixing unit.

17. The fixing device as claimed in claim 16, wherein an oldest set of the history data in the storing unit is replaced by a newest set of the history data, every time the infrared ray detection unit, the first temperature detection unit, and the internal temperature detection unit perform the detection.

18. The fixing device as claimed in claim 15, wherein the selecting unit selects the correction table after the temperature of the fixing unit is increased to a predetermined temperature and before the fixing medium contacts the fixing unit.

19. The fixing device as claimed in claim 15, wherein contents of the correspondence table are determined by an equation:
T={(k₁·P+k₂+T₀⁴)/ε}^{1/4}
wherein
T is the surface temperature of the fixing unit;
P is the level of the electric signal outputted from the infrared ray sensor;
k₁ is a constant specific to the infrared ray sensor;
k₂ is a constant specific to the infrared ray sensor;
T₀ is the temperature of the infrared ray sensor detected by the temperature sensor; and
ε is an emissivity of infrared rays of the fixing unit.

20. The fixing device as claimed in claim 14, wherein the relation data is a correspondence equation among the ideal output value, the temperature detected by the internal temperature detection unit, and the actual temperature of the fixing unit,
wherein the storing unit further stores a group of correction equations showing different relationships between the output value and the ideal output value; and
the second temperature detection unit includes:
a first determining unit that determines a first ideal output value corresponding to a first output value based on the temperature of the fixing unit detected by the first temperature detection unit as the actual temperature, a first temperature detected by the internal temperature detection unit, and the correspondence equation;
a selecting unit that selects a correction equation from the group of correction equations, the correction equation corresponding to a relationship between the first ideal output value and the first output value;
a second determining unit that determines a second ideal output value corresponding to a second output value by using the selected correction equation; and
a third determining unit that determines a temperature of the fixing unit from the correspondence equation based on the second ideal output value and a second temperature detected by the internal temperature detection unit as the temperature of the fixing unit.

21. The fixing device as claimed in claim 20, wherein the storing unit stores at least two sets of history data relating to the first output value of the infrared ray detection unit, the temperature detected by the first temperature detection unit, and the first temperature detected by the internal temperature detection unit;
the second determining unit determines a plural of the second ideal output values based on each set of the history data stored in the storing unit; and
the third determining unit determines a temperature of the fixing unit from the correspondence equation based on an average value of the plural of the second ideal output values and the second temperature detected by the internal temperature detection unit as the temperature of the fixing unit.

22. The fixing device as claimed in claim 21, wherein an oldest set of the history data in the storing unit is replaced by a newest set of the history data, every time the infrared ray detection unit, the first temperature detection unit, and the internal temperature detection unit perform the detection.

23. The fixing device as claimed in claim 20, wherein the selecting unit selects the correction equation after the temperature of the fixing unit is increased to a predetermined temperature and before the fixing medium contacts the fixing unit.

24. The fixing device as claimed in claim 9, wherein the correction unit includes:
an internal temperature detection unit that detects a temperature of the infrared ray detection unit; and
a storing unit that stores at least three sets of history data indicating a first output value, a first temperature detected by the internal temperature detection unit, and a first temperature detected by the first temperature detection unit, and
the second temperature detection unit includes:
an arithmetic equation determining unit that determines an arithmetic equation for determining the temperature of the fixing unit based on the sets of history data; and
a temperature determining unit that determines the temperature of the fixing unit by using the arithmetic equation based on a second output value, a second temperature detected by the internal temperature detection unit, and a second temperature detected by the first temperature detection unit.

25. The fixing device as claimed in claim 24, wherein an oldest set of the history data in the storing unit is replaced by a newest set of the history data, every time the infrared ray detection unit, the first temperature detection unit, and the internal temperature detection unit perform the detection.

26. The fixing device as claimed in claim 24, wherein the selecting unit selects the arithmetic equation after the temperature of the fixing unit is increased to a predetermined temperature and before the fixing medium contacts the fixing unit.

27. A fixing device comprising:
a fixing unit that contacts a fixing medium and heats the fixing medium;
a temperature detection unit provided in a non-contact manner with a surface of the fixing unit, the temperature detection unit detecting a temperature of the fixing unit based on an amount of infrared rays emitted from the surface of the fixing unit; and
a temperature control unit that controls the temperature of the fixing unit based on the temperature detected by the temperature detection unit,
wherein the temperature control unit further includes:
an amplifier circuit that amplifies an electric power outputted from the temperature detection unit, and
a temperature compensating circuit that cancels a temperature drift of the amplifier circuit.

28. The fixing device as claimed in claim 27, wherein the amplifier circuit and the temperature compensating circuit are constituted in an integrated manner.

29. The fixing device as claimed in claim 27, wherein the amplifier circuit and the temperature compensating circuit constitute a chopper amplifier.

30. An image forming device comprising the fixing device as claimed in claim 3.

31. An image forming device comprising the fixing device as claimed in claim 9.

32. An image forming device comprising the fixing device as claimed in claim 27.
